(19) United States
(12) Patent Application Publication
(10) Pub. No.: US 2019/0165877 A1
(43) Pub. Date: May 30, 2019

(54) ENERGY EFFICIENT, CONTENTIONLESS NxM ROADM WITH AMPLIFIED SINGLE WAVELENGTH DROP/ADD PORTS AND CORRESPONDING METHODS

(71) Applicant: NeoPhotonics Corporation, San Jose, CA (US)

(72) Inventors: Winston I. Way, Irvine, CA (US); Ilya Vorobeichik, Los Gatos, CA (US)

(21) Appl. No.: 16/200,949

(22) Filed: Nov. 27, 2018

Related U.S. Application Data
(60) Provisional application No. 62/591,285, filed on Nov. 28, 2017.

(51) Int. Cl. H04J 14/02; H04Q 11/00

(52) U.S. Cl. CPC H04J 14/0212; H04Q 11/0005; H04Q 2011/0047; H04Q 2011/0009; H04Q 2011/0016

(57) ABSTRACT

Improved optical network configurations are described incorporating ROADM component structures that are compatible with simplified user transceivers. The ROADM component structures generally include a reconfigurable optical add/drop multiplexer component comprising a multicast switch (MCS), a tunable optical filter (TOF), optical amplifiers, and user side ports. The MCS can be connected to network side optical conduits, while the TOF can be connected by optical conduits to the MCS and to the optical amplifiers by a distinct optical port of the TOF. The user side ports can be connected to the optical amplifiers and to light conduits of a user transceiver. In some embodiments, the MCS and the TOF can be planar optical circuits, and the optical amplifiers can be configured for single wavelength amplification. The improved ROADM component structures can be used for add-side components, drop-side components, or both—and provide for energy efficiency and/or improved device layout.

### CROSS REFERENCE TO RELATED APPLICATIONS

This application claims priority to copending U.S. provisional patent application 62/591,285 filed on Nov. 28, 2017 to Way et al., entitled “Energy Efficient Contentionless N×M ROADM With Amplified Single Wavelength DROP/ADD Ports,” incorporated herein by reference.

### FIELD OF THE INVENTION

The invention relates to reconfigurable optical add/drop multiplexers that use single wavelength optical amplifiers to more efficiently provide desired signal to noise for the optical signals. The invention further relates to reconfigurable optical add/drop multiplexers formed with a multi-cast optical switch connected to a PLC based tunable optical filter as well as to related methods of using the efficient optical switching systems.

### BACKGROUND OF THE INVENTION

Optical switching technology has been emerging to complement the electronic switching in concurrence with, and in fact enabling the increase in bandwidth of the data passing through nodes of an optical communication network. Optical switching generally treats each wavelength as a cohesive unit and passes each wavelength transparently to its destination within a node, either an output fiber or a wavelength channel associated with local traffic. A transparent optical switch can effectively establishes a physical path for the light at least at the specified wavelength on the specified input fiber to be passed linearly and directly to the desired output fiber or local port. Similarly, a transparent optical switch configured for a transmission configuration effectively establishes a physical path for the light at least at a specified wavelength on a local input fiber to be passed linearly and directly to a selected combined wavelength output fiber.

Such a switch essentially passes any optical data regardless of format or content as long as it is within the optical wavelength range specified for that optical channel. Since the optical switch cannot modify the detailed data within the optical wavelength, it is not as flexible as an electronic switch. But more significantly, the power required to switch the data for that wavelength is merely the amount of power needed to establish and maintain the optical path through the switch, which is generally orders of magnitude less than required for electronically switching the same data. As power consumption is often the limiting factor for the bandwidth that can be managed by a node, optical switching is not merely a convenience of remote configuration, but clearly enables the current and future performance levels of optical networks.

### SUMMARY OF THE INVENTION

As described herein, improved optical network configurations are described incorporating ROADM component structures that are compatible with simplified user transceivers while providing efficient ROADM functions.

In a first aspect, the invention pertains to a reconfigurable optical add/drop multiplexer component comprising an N×M multicast switch, a tunable optical filter, P optical amplifiers, and P user side ports. The N×M multicast switch can be connected to N network side optical conduits, in which N, M are integers each ≥1. The tunable optical filter can have M or P channels (1≤P≤M) and with two sets of M or P optical ports, in which a first set of optical ports are connected by optical conduits to the N×M multicast switch. The P optical amplifiers can be configured with each optical amplifier connected to a distinct optical port of the tunable optical filter. The P user side ports can be connected to the P optical amplifiers and to P light conduits each connected to a user transceiver. In some embodiments, the N×M multicast switch and the tunable optical filter can be planar optical circuits, and the P optical amplifiers can be configured for single wavelength amplification.

In a further aspect, the invention pertains to an add-side reconfigurable optical add/drop multiplexer component comprising a PLC based N×M multicast switch, a PLC based array of variable optical attenuators, and a PLC based tunable optical filter array. The N×M multicast switch can be connected to N network side optical conduits, wherein N, M are integers each ≥1. The PLC based array of variable optical attenuators can have two sets of M or P optical ports, in which a first set of optical ports are connected by optical conduits to the N×M multicast switch. The PLC based tunable optical filter array can have M or P channels (1≤P≤M) and two sets of M or P optical ports, in which a first set of optical ports are connected by optical conduits to corresponding M or P ports of the PLC based array of variable optical attenuators and a second set of M or P ports are connected to P light conduits connected to output ports of a user transceiver.

In another aspect, the invention pertains to an optical telecommunications node comprising N input optical signal conduits, wherein N is an integer ≥1; N output optical signal conduits; M single wavelength input optical signal conduits, wherein M is an integer ≥1; M single wavelength output optical signal conduits; a reconfigurable optical add/drop multiplexer (ROADM); P input single wavelength optical fibers, P≤M, wherein each input single wavelength optical fiber is configured in an add configuration to receive an optical signal from a transmitter; P output single wavelength optical fibers, wherein each output single wavelength optical fiber is configured in a drop configuration to transmit an optical signal to a receiver. The ROADM can comprise an add side PLC multicast switch, a drop side PLC multicast switch, two arrays of PLC tunable optical filters (TOF) with one array of TOF configured on the add configuration multicast switch and with one array of TOF configured on the drop configuration multicast switch, in which the ROADM connects the N input optical signal conduits with the M single wavelength output optical conduits through the drop side multicast switch and connects the N output optical signal conduits with the M single wavelength input signal conduits through the add side multicast switch.

In some embodiments, a ROADM component corresponding to a portion of a ROADM providing add or drop functions, comprises user side (single wavelength) optical amplifiers, e.g., erbium-doped fiber amplifiers, along with an array of tunable optical filters integrated on the user side of a ROADM component, either as an add on of or within the same structure as, a multicast switch. The configuration provided herein may allow in some embodiments for achievement of higher gain for a given power expenditure from the amplifier due to the amplification of a single wavelength input signal into the amplifier positioned following a tunable optical filter, and in other embodiments for more efficient network integration. In alternative embodiments for an add-side ROADM component, a tunable optical filter can be used to decrease noise originating from the add signal to provide for a lower power add signal through the ROADM component with acceptable optical signal to noise ratio. With either embodiment, a user side transceiver, i.e., transmitter/receiver) can be used without a separate conventional single wavelength erbium doped fiber amplifier.

The improved integrated ROADM component structures can be used for add-side components (receiving user transmissions for insertion into the network), drop-side components (directing optical signals to specific users), or both. In addition, the device configurations provide for energy efficiency and/or improved device layout.

The ROADM component comprises a multicast switch that can receive a drop side signal from a wavelength selective switch or direct an add signal to a wavelength selective switch. The wavelength selective switches and route the corresponding signals to an appropriate input/output line of the node. In the embodiments described herein, the ROADM components generally comprise an array of tunable optical filters, which can be provided planar optical circuits (PLC), as well as, in some embodiments, variable optical attenuators.

In a first set of embodiments, an erbium-doped fiber amplifier (EDFA) is placed on the user side of a ROADM component. An array of tunable optical filters can be placed between a multicast switch and the EDFAs such that the EDFA operate to amplify a single wavelength. With amplification for a single wavelength, the pump power can be correspondingly reduced to obtain a desired gain. In particular, since the gain of an erbium-doped fiber amplifier is generally non-linear with respect to input optical power, the gain realized with the improved structures can be performed based on the lower power single wavelength signal with a reduced pump laser power such that the device has improved laser efficiency.

In additional embodiments for add-side components, a transmitter can be equipped for amplification with a solid state optical amplifier such as a semiconductor optical amplifier (SOA). The signal provided by the transmitter can be directed to a ROADM component with a user side tunable optical filter that can reduce noise through filtering out wavelengths not corresponding to input wavelengths, including broader non-signal emissions introduced by the optical amplifier. The use of the tunable optical filter can provide for efficient routing through the multicast switch at a desirable degree of optical signal to noise ratio (OSNR) with less amplification of the add signal. A single wavelength erbium doped fiber amplifier or other optical amplifier can be configured on the network side of the add function multicast switch to further amplify the signal passing through the multicast switch.

Colorless, directionless, and contentionless (CDC) reconfigurable optical add-drop multiplexers (ROADMs) are a significant component of software-defined optical networks with dynamic wavelength add, drop, and routing. However, CDC ROADMs that employ N×M multicast switches (MCSs), where N is the number of degrees and M is the number of add ports or drop ports (which can be user interfaced ports), can suffer from a relatively high optical insertion loss of the broadcast-and-select-based MCSs. Thus, an array of N erbium-doped fiber amplifiers (EDFA) and/or SOAs in both the add directions and drop directions can be used to compensate for the MCS loss. The EDFA or SOA amplifiers have been added on the inputs into multicast switches to boost the power into the switches prior to dissipation due to optical loss passing through the switch. Alternative designs for ROADM components are described herein that may provide energy advantages and/or significant advantages for network layout.

Current WSS class switch cores have a single input and several outputs and each wavelength on the input can be independently routed to any of the outputs and each output can accommodate any number of the wavelengths on the input fiber. The WSS, like most classes of transparent optical switches, provides a connection between the input and output equally well for optical signals propagating from the input to an output, or propagating from the same output to the input. Therefore, the terms ‘input’ and ‘output’ are used merely as a convenience to describe the operation principle, but in practice they may be used as described or may be used in the reverse direction.

Optical nodes supporting a modest number of directions or degrees, e.g., no more than 16 directions, as well as a modest number of add/drop ports, e.g., no more than 16, are presently suitable for use with compact MCSs that are PLC based. Optical nodes serving a small number of users, such as 4 to 16 can make use of such compact MCS, such as 4×4 to 4×16 MCS for 4 directions/degrees. Through the use of expandable MCS, these can be expanded to 16×4 to 16×16 MCS or larger through an array of interconnected MCS, and other dimensions of MCS with expansion with respect to input and/or output degrees being possible. Expandable PLC based MCS architectures are described further below.

As with all communication networks, optical networks integrate switching functions to provide for various connections to provide for routing of transmissions. For example, longer range transmission pathways are connected with branches to direct optical signals between ultimate pathways associated with the sender and recipient. Separation of particular communications or portions thereof can be based on wavelength and/or temporal differentiation within a combined transmission sent over longer range trunk, i.e., combined signal, lines. At some location on a network, an optical band can be split to isolate specific signals within the band for routing, and similarly individual communications are combined for transmission over combined signal lines. The optical switching function can be performed using electronic switching by first converting the optical signal into an electronic signal with appropriate receiver(s). However, cost ultimately can be significantly reduced, and/or switching capacity significantly increased, if an efficient optical switching can be performed with reduced conversion of optical signals into electronic signals.

If the optical switching cannot be appropriately scaled, optical switching can only be used in limited network architectures. Optical and electronic switching complement each other in applications for optical networks. Though improvements are still coming, the basic character of electronic switching is well established. The technology for optical switching however is still emerging and various innovations are still needed for optical switching devices to begin to fully address their expected domain. Present and forthcoming optical switching systems generally fall into a few basic architecture classes. Switches for the current applications can be referred to as reconfigurable optical add-drop multiplexer (ROADM). For the formation of colorless, directionless and contentionless ROADM, an embodiment can be used with an array of wavelength-selective switch (WSS) connected to each input direction and the output of the WSS switches are directed to an array of multicast switches (MCS) that can route the split signals from the WSS to a selected drop or output port.

It is an unfortunate circumstance of optical networking arts that there are two very different items that bear the designation ‘ROADM’. A legacy ROADM provides the capability to independently determine for each wavelength in an input fiber whether that wavelength is routed to the corresponding output fiber or dropped to a local port or different fiber pair. Additionally in a legacy ROADM, any wavelength that is dropped and thus not directly routed to the output can be used to introduce new optical data streams from the local ports or other fiber pair into the output fiber. A legacy ROADM can also be referred to as a ROADM component, but there are also higher-degree ROADM systems that can be used to selectively drop or route through individual wavelengths among a larger number of input/output fiber pairs. Originally ROADM systems were simply collections of legacy ROADM components and the control systems that tied them together and the common name presented no problem. These higher-order ROADMs have, however, evolved and often comprise some of the other classes of optical switches including, for example, WSS, optical cross connect switches (OXC) and MCS. Legacy ROADM components still exist, but the ROADM term more commonly now refers to the higher-order system. Subsequently the term ROADM herein, unless specifically indicating otherwise, shall refer to the higher-level ROADM system.

A N×M multicast switch uses N1×M splitters at the N input channels to distribute all the optical signals in each input port towards each of the M outputs. Each of the M outputs has its own N×1 selector switch to isolate the signals from the desired input port. The MCS has the basic advantage of having no optical filtering, so it is not only transparent to the data in each wavelength, it is transparent to the wavelength set configuration itself (“colorless”), i.e. wavelength channels do not need to conform to any specific wavelength grid specifications or channel bandwidths. The primary cost of this added transparency is the reduction of signal power due to the optical splitting on the input stages, and the MCS in some applications involves an array of optical amplifiers to boost the signal level and compensate the additional loss for each input. Expandable PLC MCS are described below.

In an optical network node, drop and add lines can branch from longer range optical transmission lines (fibers). The specific add and drop signals are then further routed from specific input lines (for add) or into specific output lines (for drop). As noted above, a ROADM can function as such a node. The improvements herein are directed to components of such a ROADM, in which the ROADM components are situated along the add side, the drop side or separately on both add and drop sides of the ROADM add/drop branches. An objective of the alternative structures can be the simplification to user transceivers, although the improvements described herein may focus on the ROADM components and/or on the broader network architecture, such as the transceiver structure. While improvements may derive from implementation for both add side and drop side components, the improvements that follow may not be parallel for add and drop sides.

The designs of the improved ROADM components generally comprise a tunable optical filter (TOF) on the user side of a multicast switch. On the drop-side, the tunable optical filter provides a single wavelength signal into the ROADM output ports. If the single wavelength output signals are directed to EDFA, the single wavelength amplification can be performed with high energy efficiency due to the functional dependence of the EDFA gain on power. Using the configuration, pump laser power can be distributed over multiple EDFA for efficiency. On the add-side the TOF provides for a reduction of noise coming from user side amplifiers so that a reduced noise and corresponding improved signal to noise ratio results from transmission from the multicast switch for a given input power received from the user transponder. Thus, while the potential advantages of a user side TOF on the add-side and drop-sides may be distinct, TOF can be advantageously added to the add-side and/or drop-side of the ROADM components. As explained more below, the TOF can be introduced in a planar lightwave circuit format, for example, as an array on a PLC chip, which may or may not be integrated into a single PLC chip with a PLC based MCS.

On the user side of an ROADM, an add-side ROADM component and a drop-side ROADM component can be connected to optical conduits, e.g., optical fibers, that are directed to a plurality of user transceivers that provide the user with input and output functions. The add and drop connections of the transponders can further comprise within the transponder, filters, variable optical attenuators, and/or amplifiers. To the extent that the ROADM component designs can simplify the user transceiver structures, such changes would be desirable to meet objectives of device standards that involve shrinkage of transceiver sizes. For example, in some embodiments, user transceivers can have transmitter functions without variable optical attenuators or TOF by moving these functions to the ROADM components connected to the transmitters. Also, in some embodiments, the transceivers can have transmitter functions with solid state optical amplifiers replacing conventional EDFA to provide a significant power, size and/or cost reduction for the transceiver. The replacement within a user transceiver of an EDFA with solid state optical amplifiers may result in a transmitted signal that can be transmitted through the receiving ROADM component with sufficient optical signal to noise based on the TOF placed in the add-side ROADM component. A tunable optical switch on the ROADM component may provide for elimination of a tunable optical filter from a user transponder.

A TOF on the user side of an MCS allows for amplification of a single wavelength for an EDFA on the user side of the MCS for the drop component and on the network side of the MCS for the add component. In either case, the amplification of a single wavelength signal provides energy advantages. Depending on the particular design, different advantages may flow from the design. The ROADM component further comprises an N×M multicast switch (MCS) that provides for routing of N input channels into the switch to M MCS output channels, which may be directed to (drop) or from (add) specific users. The MCS can provide direction mitigation. The N MCS input channels can be generally configured for chromatically combined signals. The MCS input channels may or may not have optical amplifiers, such as EDFA. The MCS input channels can be connected on the network side to wavelength selective switch or the like that provides contention mitigation for the N input channels.

In improved configurations, the user side of the ROADM component has an array of tunable optical filters followed by, structurally, a single wavelength optical amplifier. On the drop side, the tunable optical filter can provide for a single wavelength entering the optical amplifier, and on the add side the tunable optical filter can provide for a reduction of noise from out-of-band optical emissions from the amplifier. A tunable optical filter only on the drop side was described by Watanabe et al., “Silica-based PLC Transponder Aggregators for Colorless, Directionless, and Contentionless ROADM,” OFC/NFOEC Technical Digest, OTh3D.1 (2012), incorporated herein by reference. Watanabe indicates that the tunable optical filter provides for the selection of the desired wavelength from the optical switch. Watanabe does not describe single wavelength EDFA on the user side of the TOF, and Watanabe does not suggest the TOF for use on the add side.

The user side optical amplifier can comprise an erbium-doped fiber amplifier or a semiconductor optical amplifier. Both types of optical amplifiers are commercially available. For the add side ROADM component.

The output from the amplifier can be directed to an optical receiver, or the amplifier can be configured to amplify a signal from a transmitter that is then directed to the ROADM. In some embodiments, a distributed laser optical pump can be used to power the amplifiers. The ROADM generally is configured as a node in an optical telecommunication network, such as at the end of a communication line at which users interface with the network.

### BRIEF DESCRIPTION OF THE DRAWINGS

FIG. 1A is a schematic view of an N×M multi-cast switch of the prior art configured for drop-side functionality in a ROADM.

FIG. 1B is a schematic view of an N×M multi-cast switch of the prior art configured for add-side functionality in a ROADM.

FIG. 2A is a schematic view of an N×M multi-cast switch configured for drop-side functionality in a ROADM, according to one or more embodiments of the disclosure.

FIG. 2B is a schematic view of an N×M multi-cast switch configured for add-side functionality in a ROADM, according to one or more embodiments of the disclosure.

FIG. 2C is a schematic view of an N×M multi-cast switch configured for add-side functionality in a ROADM, according to one or more embodiments of the disclosure.

FIG. 3 is a system diagram of a network node based on a reconfigurable optical add drop multiplexer configured with add-side and drop-side optical switches, according to one or more embodiments of the disclosure.

FIG. 4 is a representative connection for an EDFA optical amplifier, according to one or more embodiments of the disclosure.

FIG. 5A is a schematic view of a ROADM drop/add component including an MCS and associated structure, according to one or more embodiments of the disclosure.

FIG. 5B is a schematic view of a ROADM drop component including an MCS and associated structure, according to one or more embodiments of the disclosure.

FIG. 5C is a schematic view of a ROADM add component including an MCS and associated structure, according to one or more embodiments of the disclosure.

FIG. 6 is partial schematic view of the structure of a ROADM is depicted at an interface between one or more pump lasers, EDFAs and a TOF array on a drop-side, according to one or more embodiments of the disclosure.

FIGS. 7A-7B are partial schematic views of the add-side structure of a ROADM at an interface between one or more pump lasers, EDFAs and a TOF array, according to one or more embodiments of the disclosure.

FIG. 8 is a schematic view of the switching within a 4×8 MCS switch.

FIG. 9 is a schematic view of two coupled expandable 4×8 MCS switches configured to function as an 8×8 MCS.

FIG. 10 is an expanded view of a set of 1×2 optical switches configured to interface the MCS switch with expansion in lines and optical output lines.

FIG. 11 is an expanded view of an alternative embodiment of 1×2 optical switches configured to interface the MCS switch with expansion in lines and optical output lines.

FIG. 12 is an illustration of cascading three 4×16 expandable MCSs to form a 12×16 MCS.

FIG. 13 is an optical circuit of a tunable optical filter of the prior art.

FIG. 14 is a structure for providing pump light to the EDFAs, according to one or more embodiments of the disclosure.

FIG. 15 is a schematic view of the dynamic distribution of laser power through the design of a laser diode on a common substrate with a controller to implement the dynamic power distribution, according to one or more embodiments of the disclosure.

FIG. 16 is a schematic view of a ROADM, according to one or more embodiments of the disclosure.

FIG. 17 is a schematic view of a ROADM, according to one or more embodiments of the disclosure.

FIG. 18 is a schematic view of a user transceiver, according to one or more embodiments of the disclosure.

FIG. 19 is a schematic view of a user transceiver of particular usefulness with certain designs/configurations of a ROADM, such as the ROADM depicted in FIG. 17, according to one or more embodiments of the disclosure.

FIG. 20 is a schematic view of a user transceiver of particular usefulness with certain designs/configurations of a ROADM, such as the ROADM depicted in FIG. 16, according to one or more embodiments of the disclosure.

FIG. 21 is calculations of optical signal to noise ratio (OSNR) penalty at the signal destination for models based on the structures described herein.

### DETAILED DESCRIPTION OF THE INVENTION

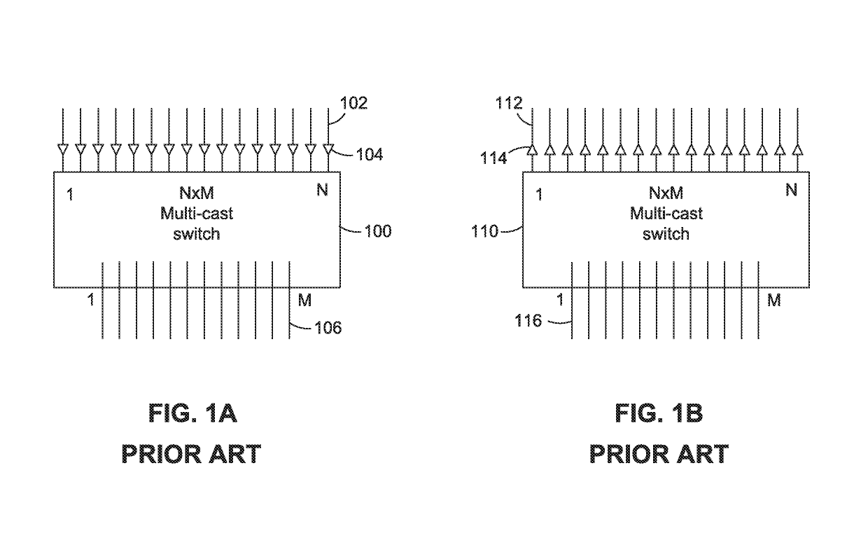

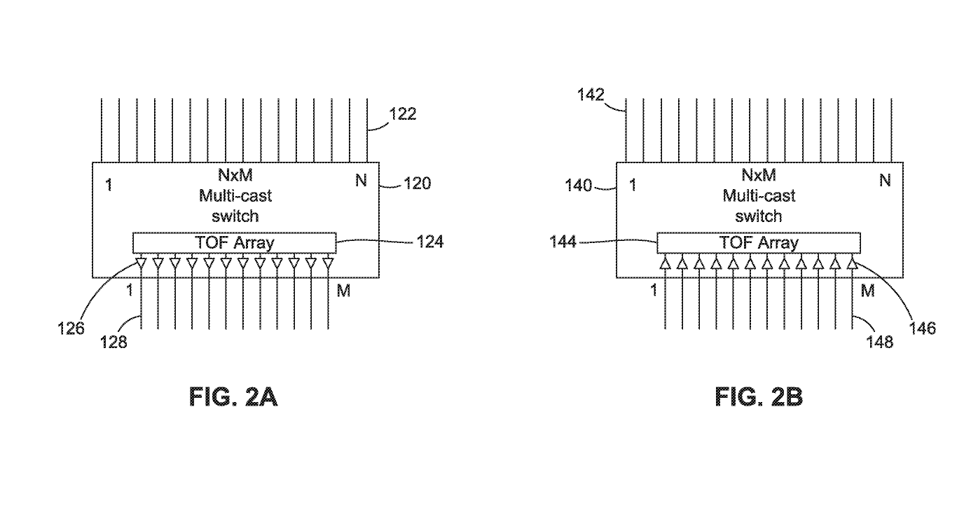

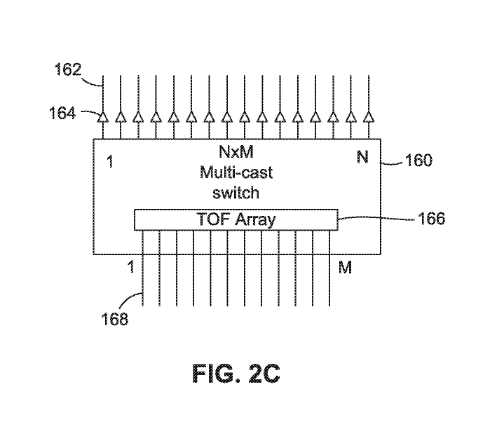

Referring to FIGS. 1A-1B and 2A-2C, the basic structure of an embodiment of an improved ROADM component is shown in FIGS. 2A-2C contrasted with a conventional structure shown in FIGS. 1A-1B.

Specifically referring to FIG. 1A, an N×M multi-cast switch (MCS) 100 configured for drop side functionality is depicted. The MCS 100 includes a plurality of network ports 102, optical amplifiers 104, and a plurality of drop ports 106. Depicted in FIG. 1A, the optical amplifiers 104 are a plurality of erbium-doped fiber amplifiers (EDFA) that are associated with each of the network ports 102 and are configured to amplify input network signals prior to delivery into the MCS 100. The plurality of EDFA 104 is configured to amplify chromatically combined optical signals.

Referring to FIG. 1B, a conventional N×M MCS 110 configured for add side functionality is depicted. The MCS 110 includes a plurality of network ports 112, optical amplifiers 114, and a plurality of add ports 116. Depicted in FIG. 1B, the optical amplifiers 114 are a plurality of EDFAs that are associated with each of the network ports 112 and are configured to amplify output network signals subsequent to delivery from the MCS 110.

Referring to FIG. 2A, an improved ROADM drop component comprises an N×M MCS 120 configured for drop side functionality, according to one or more embodiments of the disclosure. The MCS 120 comprises a plurality of network ports 122. The ROADM drop component further comprises a tunable optical filter (TOF) array 124 optically connected to the MCS switch, optical amplifiers 126 optically connected to TOF array 124 and a plurality of drop ports 128.

As depicted in FIG. 2A, the structure of the MCS is configured to receive input network signals via the plurality of network ports 122 and deliver the input signals to the TOF array 124. In various embodiments the TOF array 124 selects an appropriate wavelength for the associated user, filters the received input network signal based on the selected wavelength and transmits the filtered optical signal via the plurality of drop ports 128, which can be directed to a user's transceiver.

In various embodiments, and depicted in FIG. 2A, the selected wavelength is amplified using the plurality of optical amplifiers, such as a plurality of EDFAs, that are associated with each of the drop ports 128.

Since the optical power has been attenuated by losses including the loss associated with the MCS 120, the optical signal input into the optical amplifiers 126 connected to each output port of the TOF array 124 has reduced power. By further selecting a single optical wavelength using TOF array 124, the optical signal directed to the EDFA can be further attenuated.

Referring to FIG. 2B, an innovative enhancement to an add-side ROADM component is depicted with an N×M MCS 140 configured for add-side functionality, according to one or more embodiments. An optical add/drop multiplexer, as the name implies, provides an ‘add’ function wherein new locally-created signals can be inserted back into the shared core network on available wavelengths. As such, the add-side ROADM component further comprises a plurality of network ports 142, a tunable optical filter (TOF) array 144, optical amplifiers 146 and a plurality of add ports 148.

In this embodiment, each input signal, such as from a user transceiver, first passes in sequence through the optical amplifiers 146, such as a plurality of EDFAs, and is delivered to the MCS 140 with integrated TOF array 144 before passing on, via the plurality of network ports 142, through the stages of the MCS add side.

In general, since the signal to the EDFA comes from a single transmitter, the optical amplifiers 144 are inherently operating in ‘single-lambda’ mode, the characteristics of which are described subsequently. Since the structure of the MCS 140 is inherently conducive to significant optical loses, due to the fundamental and desired operating principles of MCS switching, the optical amplifiers 144 provide amplification of the pure signal to pre-compensate for the inherent loss of the MCS add function. Subsequent to the MCS add operation, the added signal is no longer independently available for such manipulations until it reaches its drop destination (and may then receive further innovative drop-side enhancements as described prior).

In addition, the optical amplifiers 146, particularly in single-lambda mode, also emits into its output Amplified Stimulated Emission (ASE) background light at wavelengths away from the signal wavelength. Absent any corresponding adaptation, that ASE background light would proceed through the add side of the MCS and into the core network, adding noise for the signals already in the core network at those other wavelengths. This additional noise would make it noticeably more difficult to faithfully recover those other signals at their final destinations, impairing the core network as a whole.

Therefore, the second element of the innovation is the use of a transmissive bandpass optical filter, such as the TOF array 146. In one or more embodiments, the TOF array 146 is configured to efficiently pass the wavelengths at and near the desired signal, but effectively block the ASE noise for the non-signal wavelength ranges, thereby preventing most of the ASE noise from being passed into the core network.

In addition, the available wavelengths for carrying signal in the shared core network change with time as different signals are passing by, and that wavelength availability is generally not predictable. Therefore, each local transmitter directed at the add side can be rapidly tuned to any available wavelength indicated by the control systems of the core network. In various embodiments the optical amplifiers 146 will work for any of the utilized wavelengths and do not require any control response to a wavelength selection; although minor active optimizations for varying wavelengths can be possible.

The passband of the TOF array 144 however tracks the selected wavelength of its corresponding transmitter. Therefore, the optical filter subsequent to the optical amplifiers 146, as depicted in FIG. 2B, is preferably a TOF array as described herein, and further may preferably be an element of an integrated TOF array 144 as described herein.

Referring to FIG. 2C, an alternative embodiment of an N×M MCS 160 configured for add-side functionality is depicted, according to one or more embodiments. The MCS 160 comprises a plurality of network ports 162, optical amplifiers 164, a TOF array 166, and a plurality of add ports 168.

In this embodiment, in operation, each input signal first passes in sequence through the TOF array 166, which is depicted in FIG. 2C as being integrated with the MCS 140, and passes through the structure of the MCS to the optical amplifiers 164, which are associated with each of the plurality of network ports 142. Once amplified, the received signal is passed on, via the plurality of network ports 142, into the core network.

In operation, since the signal to the EDFA comes from a single transmitter, the optical amplifiers 144 are inherently operating in ‘single-lambda’ mode, the characteristics of which are described subsequently. Since the structure of the MCS 140 inherently results in splitting of the optical power, due to the fundamental and desired operating principles of MCS switching, the optical amplifiers 144 provide amplification of the pure signal to pre-compensate for the inherent loss of the MCS add function. Subsequent to the MCS add operation, the added signal is no longer independently available for such manipulations until it reaches its drop destination (and may then receive further innovative drop-side enhancements as described prior).

The gain achieved from an EDFA is a function of the input optical power. A nature of the EDFA is that the gain expressed as a multiple of the input power is not constant, and a lower multiple may be obtained when amplifying a plurality of input signals and/or more powerful input signals. Therefore, for a given pump energy delivered to the EDFA, a weaker optical signal can receive a greater proportional amplification. Therefore, the structure of the MCSs in FIGS. 2A-2C may achieve a suitable output optical power delivered to an output channel using a lower pump energy.

The use of a planar lightwave circuit (PLC) comprising a TOF connected to the output of a drop-side MCS is described in Watanabe et al., “Compact PLC-based Transponder Aggregator for Colorless and Directionless ROADM,” Optical Society of America, Optical Fiber Communications Conference, National Fiber Optic Engineers Conference, 2011, paper OTuD3, incorporated herein by reference. This article describes the use of the resulting structure for the replacement of a wavelength cross connect switch, and the TOF is supplied to enhance the colorless and directionless nature of the structure. The article does not consider optical amplifiers or power considerations. Also, the article does not teach a TOF for an add-side MCS or suggest any utility for such a structure.

An M×N multicast switch has M input ports and N output ports, which in an isolated switch are arbitrary since the switch can generally be connected in either orientation. But an input signal received at an input port can then be directed to any or all of the output ports. To increase the applicability of MCS, expandable MCS have been described, see U.S. Pat. No. 8,891,914 B2 to Ticknor et al. (hereinafter the '914 patent), entitled “Scalable Optical Switches and Switching Modules,” incorporated herein by reference. The MCS in the present ROADM structures can be implemented with expandable switches as described in the '914 patent.

The implementation of a ROADM based on an MCS with a design that avoids amplification is described in U.S. Pat. No. 9,742,520 B1 to Way et al., entitled “Optical Switching System with Colorless, Directionless, Contentionless, ROADM Connected to Unamplified Drop Channels,” incorporated herein by reference. In contrast, the present system designs rely on amplifiers to provide desired signal to noise over a broader range of network conditions as well as optionally with less robust receivers.

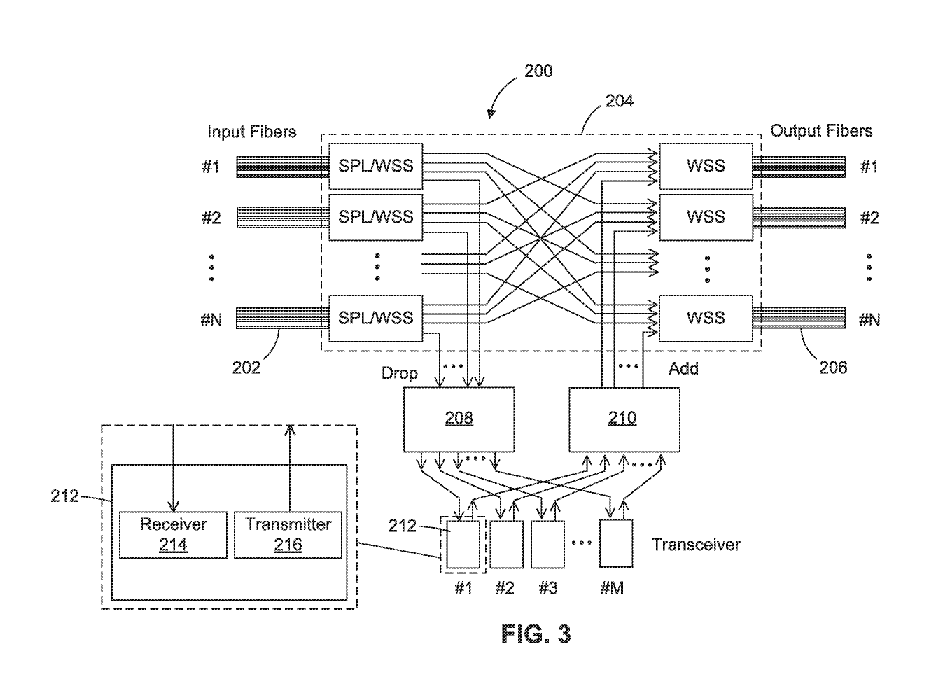

Referring to FIG. 3 a system diagram of a network node 200 including an optical cross-connect switch 204 configured with add-side and drop-side optical switches 208, 210 is depicted. In one or more embodiments, the optical cross-connect switch 204 comprises a plurality of input fibers 202 (N input fibers 202 where N is an integer >1) and a plurality of output fibers 206 (N output fibers 206) and comprises a plurality (1×N) of drop-side splitter/switches, each optically coupled with one of the input fibers 202, and a plurality (1×N) of add-side switches, each optically coupled with one of the output fibers 206.

Depicted in FIG. 3, in certain embodiments the drop-side splitter/switches could be composed of a plurality of optical splitters or alternatively composed of a plurality of wavelength selective switches (WSSs). In either scenario, the add-side switches can be composed of a plurality of WSSs. In such embodiments, each of the plurality of drop-side splitter/switches can comprise a plurality of optical channels that are each connected with one of the add-side switches.

In operation, where the plurality of drop-side splitter/switches are configured as optical splitters, signals from input fibers 202 are broadcasted by the optical splitters to the plurality of add-side switches. Once received by the add-side switches, the signal to be launched into the desired outgoing fiber 206 is selected by the WSS. In operation, where the plurality of drop-side splitter/switches are configured as WSSs, incoming signals are individually routed by the drop-side WSSs, and combined by the add-side WSS switches.

In addition to the above, in various embodiments each of the plurality of drop-side splitter/switches comprise one or more optical channels that are configured as a drop port—optically connected with the drop-side optical switch 208 positioned outside of the optical cross connect switch 204. Similarly, each of the add-side switches of the cross connect switch comprise one optical channel that is configured as an add port—optically connected with the add side optical switch 210 positioned outside of the optical cross-connect switch 204.

In various embodiments, the drop side optical switch 208 and add side optical switch 210 are optically connected with a plurality of user transceivers 212 (M transceivers, where M is an integer >1). In certain embodiments, the user transceivers 212 can comprise an internal receiver 214 and transmitter 216, although they can be configured separately. In such embodiments, the receiver 214 may be optically connected with the output of the drop-side optical switch 208 while the transmitter 216 may be optically connected with the input of the add-side optical switch 210.

In FIG. 3, the ROADM is configured for providing drop/add function as a network node between N network fibers that generally can come from different directions. Similarly, the ROADM is configured to interfacing with M transceivers, i.e., receiver and transmitter structures, which may or may not be packaged together into single transceiver module, such as a plug in module. Both the transmitter and receiver perform transducing functions through the interconversion of optical signals into electrical signals or vice versa, and the transceivers can alternatively be referred to as transponders. N can be 1, 2, 3, 4, 5, 6, 7, 8, 16, 32 or other integer value. Similarly, M can be 1, 2, 3, 4, 5, 6, 7, 8, 9, 10, 11, 12, 13, 14, 15, 16, 20, 24, 36, or other integer value. A person or ordinary skill in the art will recognize that additional values of N and M are contemplated and are within the present disclosure.

As described herein, improved embodiments are directed to drop-side ROADM components and/or add-side ROADM components that provide an N×P switching function from the cross connect switch to the output ports interfacing with the transducers. While not depicted in FIG. 3 and as depicted in later figures, the switching function can be provided for P drop or add side ports, where P≥M, where P−M can be 0, 1, 2, 3, 4, 5, 6, 7, 8, or greater integer values. A person of ordinary skill in the art will recognize that additional values of P and P−M are contemplated and are within the present disclosure. If P>M, the additional add/drop side ports can be used for contention mitigation and/or for expansion capabilities for the later addition of more users. Improved structures are described for both drop-side ROADM components and add-side ROADM components. While FIG. 3 depicts a ROADM with both drop and add functions, in principle, improved structures can be used in systems providing only add functions or only drop functions. Some components, such as arrays of tunable optical filters, variable optical attenuators, and/or semiconductor optical amplifiers may be configured with either M or P components in the array depending on the implementation to provide expansion capabilities or not or integration considerations of the various components, and this design flexibility can apply to the various embodiments depicted herein.

As used herein, optical conduits generally refer to optical fibers or optical waveguides. Generally various components can be connected using either type of optical conduit, although one type may be desirable for a particular configuration. Optical connectors to provide for attachment of the optical conduits with the various components are known in the art and are commercially available. If components are integrated into a monolithic planar lightwave circuit (PLC), such as a silica planar structure, connecting waveguides are integral to the PLC design.

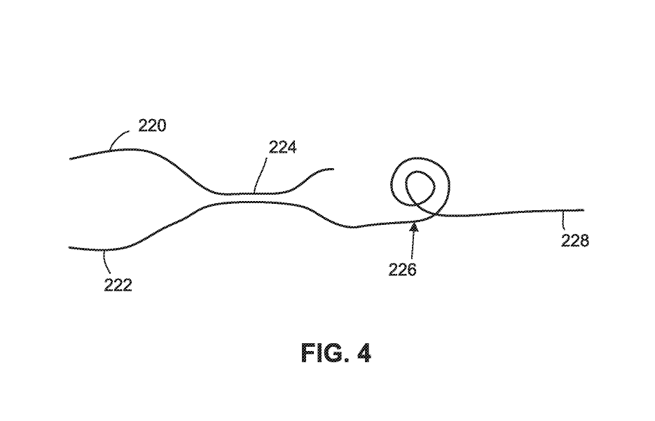

Referring to FIG. 4, a representative connection for an EDFA optical amplifier is depicted. In various embodiments, the representative connection comprises a first optical channel and a second optical channel, composed of fiber or a waveguide. Depicted in FIG. 4, the first and second optical channels are coupled via an optical coupler 224 with an erbium-doped fiber amplifier (EDFA) 226 positioned downstream of the optical coupler 224 and configured to receive a pump beam and an input optical signal that are coupled together to provide for amplification of the optical signal within the EDFA.

In one or more embodiments the first optical channel is configured to receive input signal 220 and the second optical channel is configured to receive a pump beam 222.

In some embodiments, the input signal 220 is a signal that correspond to an output of a TOF array. For example, as described above, in various embodiments a TOF array, such as TOF array 124, 144, 164 described above with reference to FIGS. 2A-2C, can be positioned upstream of a plurality of optical amplifiers, such as optical amplifiers 126, 146, 164. In such embodiments the TOF array can be configured to select an appropriate wavelength for the associated user, filter an input signal based on the selected wavelength and transmit the filtered signal via an optical channel, such as the first optical channel, downstream to the EDFA 226.

In one or more embodiments, the input signal 220 is directed, via the optical channel, to an optical coupler 224, which couples the optical channel to the second optical channel. The coupled signal is directed to the EDFA 226. The EDFA 226, stimulated by the pump input 222, amplifies the input signal 220, which, in various embodiments, is at a selected single wavelength from the TOF.

The amplified output of the EDFA 226 then is then directed to an appropriate pathway, such as to a user associated optical receiver or other output 228, or to a switch depending on the particular configuration. Efficient planar lightwave circuits with optical couplers/splitters are described in published U.S. patent application 2018/0299617A to Ticknor et al., entitled “Planar Lightwave Circuit Optical Splitter/Mixer,” incorporated herein by reference.

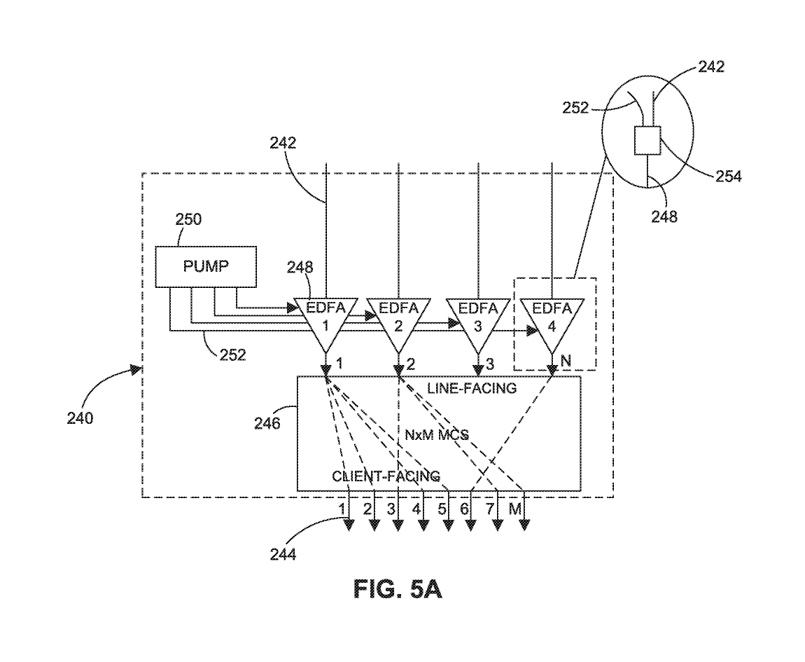

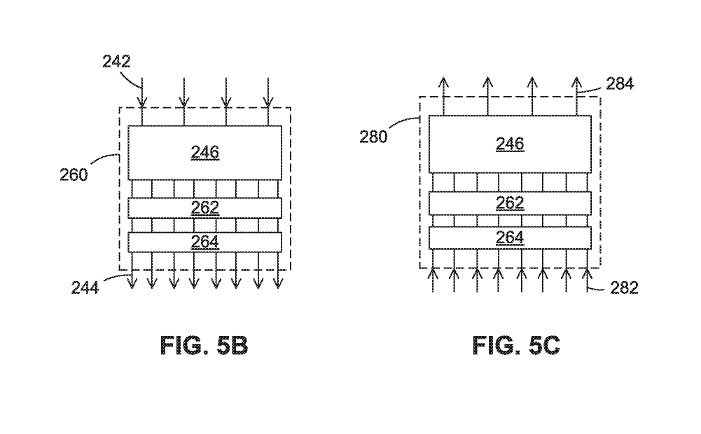

Referring to FIG. 5A, a schematic view of a ROADM drop/add component 240 including an MCS 246 and associated structure is shown. Specifically, FIG. 5A depicts a schematic view of a ROADM drop/add component 240 in the context of a providing an embodiment of a conventional structure schematically shown in FIGS. 1A-1B.

The ROADM drop/add component 240 comprises a MCS 246 with M optical conduits (user-facing) 244 and N optical conduits (line-facing) 242, N EDFA 248 optically connecting MCS inputs with N optical conduits 242. In addition, the ROADm component 240 additionally comprises a pump laser(s) 250 optically connected through N pump optical conduits 252 with EDFA components 248. Each EDFA 248 also interfaces with an optical coupler 254 to couple an input 242 and light channel 252 from the pump laser(s) 250, as shown in the insert of the figure.

The basic structure of FIG. 5A can be adapted to incorporate features to provide desired functionality as described generally herein. Referring to FIG. 5B, a schematic view of a ROADM drop component 260 comprising an MCS 246 and associated structure is shown according to one or more embodiments of the disclosure.

In various embodiments, the ROADM drop component 260 comprises a MCS component 246 with M optical conduits (user-facing) 244 and N optical conduits (line-facing) 242. In one or more embodiments, the ROADM drop component 260 additionally comprises a variable optical attenuator array 262 and a tunable optical filter array 264.

Referring to FIG. 5C, a schematic view of a ROADM add component 280 comprising an MCS 246 and associated structure is shown according to one or more embodiments of the disclosure. In various embodiments. The ROADIVI add component 280 comprises a MCS component 246 with M optical conduits (user-facing) 282 and N optical conduits (line-facing) 284. In one or more embodiments, the ROADM drop component 280 additionally comprises a variable optical attenuator array 262 and a tunable optical filter array 264.

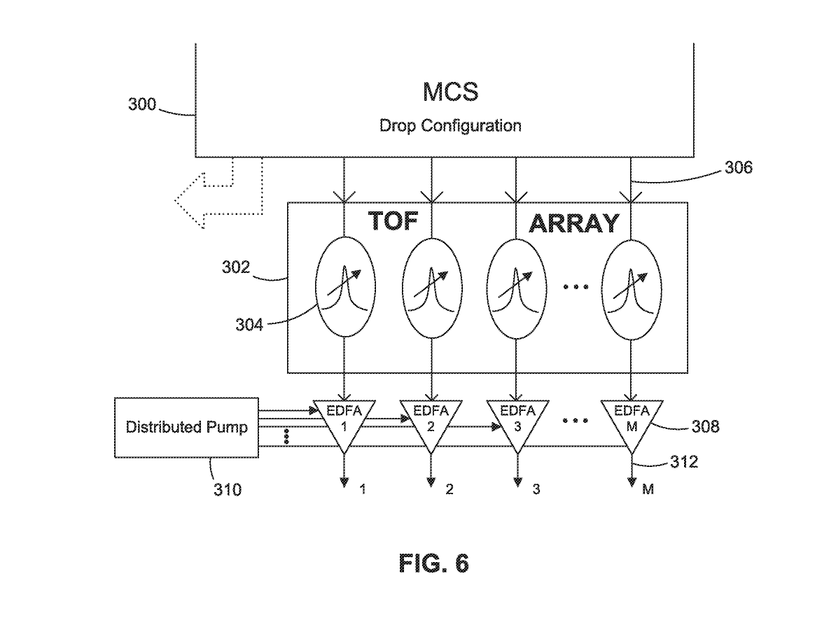

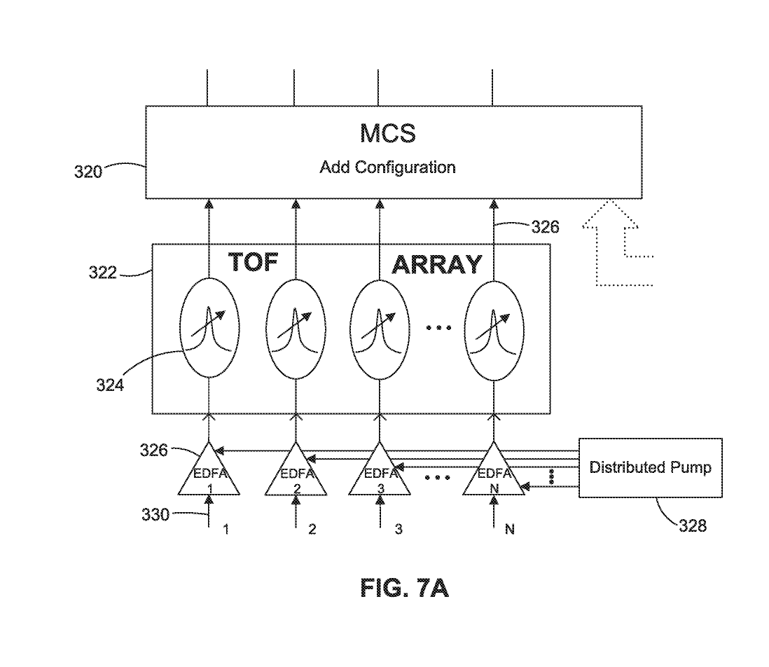

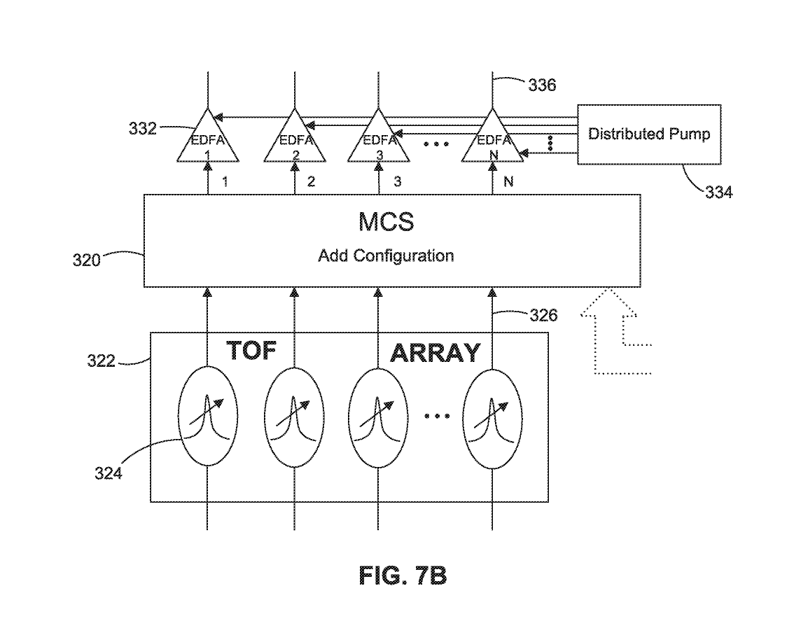

Referring to FIGS. 6 and 7A-7B, partial schematic views of the structure of a ROADM component is depicted. Specifically, partial schematic views are depicted at an interface between one or more pump lasers, EDFAs and a TOF array on a drop-side (FIG. 6) and add-side (FIGS. 7A-7B) of a ROADM, according to one or more embodiments of the disclosure.

Referring specifically to FIG. 6, in one or more embodiments the drop-side structure comprises a drop-side MCS 300, a tunable optical filter (TOF) array 302 with a plurality of lattice TOFs 304, and a plurality of EDFAs 308. The MCS 300 is configured to receive and deliver various input signals to the TOF array 302. As described above, in one or more embodiments the TOF array 302 can be introduced in a planar lightwave circuit format, for example, as an array on a PLC chip. In certain embodiments the TOF array 302 is integrated into a single chip with the MCS 300. However, as depicted in FIG. 6, in certain embodiments the TOF array 302 could be separated from the MCS 300 and optically connected via a MCS-TOF optical connector 306.

In various embodiments the TOF array 302 selects an appropriate wavelength for the associated user, filters the received input network signal based on the selected wavelength and transmits the filtered signal via a plurality of drop ports or output ports connected with the plurality of EDFAs 308.

In various embodiments the EDFAs 308 are optically coupled with a pump laser 310 that is optically coupled with the EDFAs 308 to stimulate the EDFAs 308 via a pump signal. In such embodiments, selected wavelength from the TOF array 302 is amplified using the plurality of EDFAs 308 when properly stimulated by the pump laser 310. The stimulated signal is then output downstream via a plurality of output ports 312.

Referring specifically to FIGS. 7A-7B, in one or more embodiments the add-side structure comprises an add-side MCS 320, a tunable optical filter (TOF) array 322 with a plurality of lattice TOFs 324 with a first set of EDFAs 326 (FIG. 7A) or a second set of EDFAs 332 (FIG. 7B) which can be positioned upstream or downstream of the add-side MCS 320. In general, the add-side EDFAs may be positioned on a selected side of MCS 320, and generally the EDFAs are not placed on both sides.

For instance, FIG. 7A depicts a first set of EDFAs 326, positioned upstream of the MCS 320 that are configured to receive, via a plurality of input ports 330, an add-side input signal. In one or more embodiments the first set of EDFAs 326 are configured to amplify the received input signal. For that purpose, in certain embodiments the EDFAs 326 are optically coupled with a pump laser 328 configured to stimulate the EDFAs 326 via a pump signal to amplify received input signals.

In one or more embodiments, the EDFAs 326 are optically connected with and configured to pass the amplified input signal along to the TOF array 322. In various embodiments the TOF array 322 selects an appropriate wavelength for the associated user, filters the received input signal based on the selected wavelength and transmits the filtered signal to the MCS 320. The MCS 320 is configured to receive and then pass on signals from the TOF array 322. As described above, in one or more embodiments the TOF array 322 can be introduced in a planar lightwave circuit format, for example, as an array on a PLC chip. In certain embodiments the TOF array 322 is integrated into a single chip with the MCS 320. However, as depicted in FIG. 7A, in certain embodiments the TOF array 322 could be separated from the MCS 320 and optically connected via a MCS-TOF connector 326.

Alternatively, as depicted in FIG. 7B, in certain embodiments the EDFAs 332 could be positioned downstream of the MCS 320, such that the MCS 320 is configured to transmit a filtered signal via a plurality of add ports or output ports connected with the second set of EDFAs 332.

In such embodiments the EDFAs 332 are optically coupled with a pump laser 334 that is optically coupled with the EDFAs 332 to stimulate the EDFAs 332 via a pump signal. In such embodiments, selected wavelength from the MCS 320 is amplified using the plurality of EDFAs 332 when properly stimulated by the pump laser 334. The stimulated signal is then output back into the core network via a plurality of output ports 336.

Note that the MCS 300, 320 in FIGS. 6 and 7A-7B can have additional ports that are not optically coupled through the TOF array and EDFAs. The pump lasers can be supplied as individual lasers or as an array of lasers, which can be solid state lasers assembled on a common substrate. The outputs of the MCS switch(s) are provided to the tunable optical filter array, which then provides input into the EDFAs. Suitable optical couplers couple the pump light with the input light for directing the combined signals into the EDFAs. The optical couplers can be PLC based or fiber couplers. The pump energy excited the doped glass in the EDFA that then amplifies the input signal at its wavelength due to stimulated emission.

In the preceding descriptions, the optical conformations are such that each EDFA component is primarily amplifying the optical signal on a single wavelength. In such cases it is functionally equivalent to replace the EDFA+pump with an electrically-pumped SOA. Such an exchange comes with the traditional trade-offs in performance, cost, operational requirements, and size, but is equally applicable to the present structure in any case. Thus, in any of the specific embodiments depicting an EDFA+pump, the present application includes corresponding figures and descriptions with the EDFA+pump laser, coupler, and connecting optical conduits can be correspondingly replaced in the figures and description by an electrically pumped SOA with electrical connections to the SOA to drive the SOA.

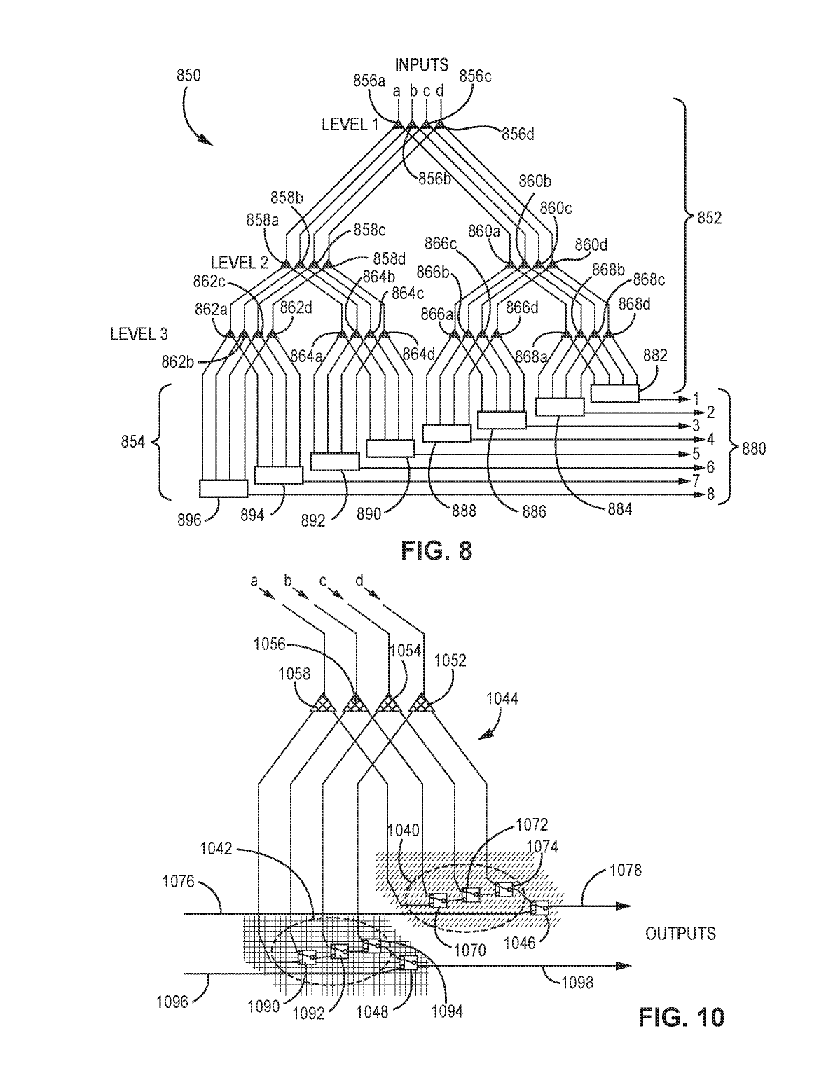

FIG. 8 depicts an embodiment of a 4×8 multicast switch. Components of the switch are arranged to illustrate their interconnections and how paths, switches, and splitters can be made to cooperate to provide expandability in a multicast application. Artisans reviewing this illustration will be able to make physical device layouts based on this schematic layout. An 8×8 PLC cross connect switch is described in Goh et al., “Low Loss and High Extinction Ratio Strictly Nonblocking 16×16 Thermooptic Matrix Switch on 6-in Wafer Using Silica-Based Planar Lightwave Circuit Technology,” Journal of Lightwave Technology 19(3):371-379 (March 2001). The rough layout of a PLC as described herein that approximately follows a layout set forth in the Goh article is shown in the '914 patent cited above. In applying the present invention to this type of physical layout, the expansion waveguides and bypass switches of the present invention can be routed adjacent to the existing waveguides and switches, retaining the existing staging, thereby imposing little or no increase to the required size of the integrated chip.

The MCS switches in the various embodiments described herein can be formed in an efficient PLC format using established processing principles and are commercially available. FIG. 8 depicts an embodiment of a 4×8 multicast switch. Components of the switch are arranged to illustrate their interconnections and how paths, switches, and splitters can be made to cooperate to provide expandability in a multicast application. Artisans reviewing this illustration will be able to make physical device layouts based on this schematic layout. An 8×8 PLC cross connect switch is described in Goh et al., “Low Loss and High Extinction Ratio Strictly Nonblocking 16×16 Thermooptic Matrix Switch on 6-in Wafer Using Silica-Based Planar Lightwave Circuit Technology,” Journal of Lightwave Technology 19(3):371-379 (March 2001). The rough layout of a PLC as described herein that approximately follows a layout set forth in the Goh article is shown in the '914 patent cited above. In applying the optical structures described herein to this type of physical layout, the expansion waveguides and bypass switches of the MCS can be routed adjacent to the existing waveguides and switches, retaining the existing staging, thereby imposing little or no increase to the required size of the integrated chip.

While in principle, the degree of the MCS can be adjusted to any value, there may be practical limits on the size, and the optical power loss through the switch may be taxing the designs. Expandable switches have been developed that provide both for control of the device footprint through connecting modules of the expandable switch to achieve the desired degree of the overall switch while leaving the option of subsequent expansion, while reducing power loss through bypass of portions of the switching function. Referring to the conceptual layout in FIG. 8, multicast switch 850 has splitter tree 852 and switching section 854. Splitter tree 852 multiplies optical inputs a, b, c, d so that each one is connected to each optical output line 1-8.

Input ports can be provided to provide optical connections from the device interface to inputs a-d. As shown in FIG. 8, splitter tree 852 has three levels to appropriately split the signal into appropriate number of optical paths, although a different number of levels can be used depending on the number of input lines and desired multicasting into particular output optical lines, and a person of ordinary skill in the art can generalize this schematic layout for different numbers of input and output lines.

Level 1 has an optical splitter on each input, with splitters 856a, 856b, 856c, 856d splitting input lines a, b, c, d, respectively to thereby make 2 branches for each input, for a total of 8 branches. The split signals are passed to level 2 splitters 858a, 858b, 858c, 858d, 860a, 860b, 860c, 860d that split the signals into 2 branches for each input to that level, for a total of 16 branches and a total of 4 signals for each of inputs a-d. The split signals are then passed to level 3 splitters 862a, 862b, 862c, 862d, 864a, 864b, 864c, 864d, 866a, 866b, 866c, 866d, 868a, 868b, 868c, 868d, that each split the signals into 2 branches thereby making 32 branches and a total of 8 signals for each of inputs a-d.

Switching section 854 connects splitter tree 852 with output lines 880 labeled 1-8 each optically connected to an output port (schematically shown as the end of the output lines). Switching blocks 882, 884, 886, 888, 890, 892, 894, 896 provided connections from splitter tree 852 to the output lines 880. Each switching block connects a signal pathway from inputs a, b, c, d to a respective output line 1, 2, 3, 4, 5, 6, 7, 8 such that a signal selected from the input ports can be selectively directed to an output line. In FIG. 8, coupling blocks are shown schematically as boxes, with specific embodiments discussed below.

Expandable optical switches have been developed to reduce optical loss associated with the expansion function through the use of low loss bypass optical channels. These expandable switches are described in more detail in the '914 patent cited above. In terms of expandable MCS switches, inputs can be coupled to bypass switches and corresponding bypass channels connected to expansion out ports that can correspondingly be connected to input ports of another MCS. Such switches with input bypass switches can provide for expansion of output connections, for example, with two N×M MCS switches functioning as an N×M′, M′≥2M, MCS. Additionally or alternatively, an expandable MCS switch can have M bypass switches on each output channel connected to M expansion in ports. Such switches with output bypass switches can provide for expansion of input connections, for example, with two N×M MCS switches functioning as an N′×M, N′≤2N, MCS. Both expansions can be continued to provide for higher multiples of input and/or output connections and MCS can comprise expansion ports on both the inputs and outputs for expansion capabilities in both dimensions. An embodiment of two 4×8 MCS switches with input expansion capability is shown in FIG. 4. In general, N can be 1 or more, in some embodiments at least about 4 and in further embodiments at least about 6 or more. M can be 2 or more, in some embodiments at least 4 and in additional embodiments at least 8 or more. A person of ordinary skill in the art will recognize that additional ranges of values of N and M are contemplated and are within the present disclosure.

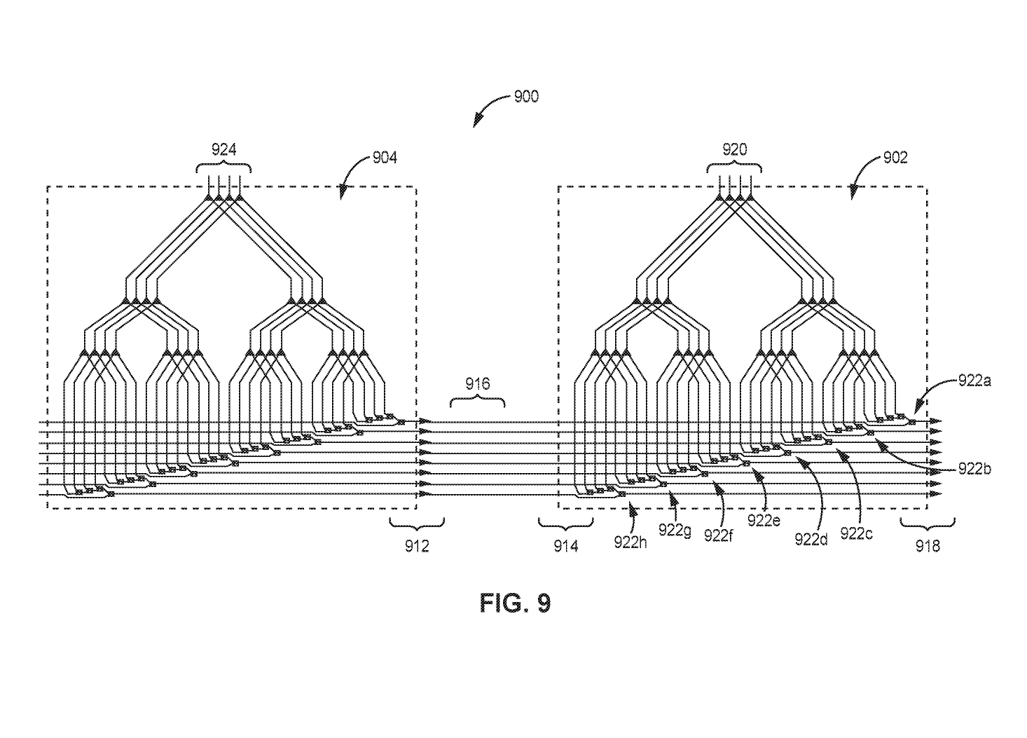

FIG. 9 depicts assembly 900 of terminal expandable switch module 902 and initial expandable switch module 904, each expandable switch module being essentially of the embodiment described as FIG. 8, with output bypass switches and corresponding bypass channels. The outputs 912 of initial module 904 are optically coupled to the corresponding expansion-in ports 914 of terminal module 902 by means of light paths 916. Expandable switch modules 902 and 904 may be for instance individual switching cores on a common planar substrate in a photonic integrated circuit (PIC) and the interconnecting light paths 916 could be optical waveguides on the same substrate.

In another example, expandable switch modules 902 and 904 may be for instance individually packaged switch modules based on separate PICs and interconnecting light paths 916 could be single-mode optical fibers either as a set of individual strands or as a fiber ribbon. Each output in output set 918 can be configured to selectively connect to one of the inputs 920 of terminal module 902 by setting the associated bypass switch in 922a-h to connect to one of the local inputs.

Alternatively, each output in output set 918 can be configured to selectively connect to one of the inputs 924 of initial module 904 by setting the associated bypass switch in 922a-h to connect to the associated expansion-in port, then further setting the appropriate switch elements in switch module 904 to connect the selected input from inputs 924 to the output in outputs 912 that is connected to the corresponding expansion-in port in expansion-in ports 914. Thereby, a 4×8 expandable MCS 902 can be upgraded by attaching a second 4×8 MCS 904 to the expansion-in ports 914 forming an assembly 900 of two 4×8 switch modules that provides the same functionality as a dedicated 8×8 MCS, with the bypass pathways reducing any associated extra loss.

FIG. 10 is an enlarged view of an embodiment of a switching block of FIG. 8 with output switches of FIG. 9 to provide for expansion. Switching blocks 1040, 1042 joining a portion of splitting tree 1044 with bypass switches 1046, 1048, respectively. Arrows a, b, c, d, depict inputs passed from level three of the splitting tree. In this embodiment, each switching block receives one input from each of the four potentially available inputs a-d through switches 1050, 1052, 1054, 1056. Each bypass switch 1046, 1048 provides a choice to output one of a-d or a signal in the bypass line. The switching blocks 1040, 1042 are arranged in a serial configuration to sequentially select between a signal from an added optical line.

Specifically for block 1040, for instance, optical switch 1070 provides for input a or b to be chosen, with the chosen signal a/b being passed to switch 1072 that provides for switching between a/b or c, with the chosen signal a/b/c being passed to switch 1074 that provides for switching between a/b/c and d. Switching block 1040 then passes one of the signals a-d to bypass switch 1046, which provides for a choice between a/b/c/d and bypass path 1076. The signal selected by bypass switch 1046 then passes to output line 1078. Similarly for block 1042, optical switch 1090 provides for input a or b to be chosen, with the chosen signal a/b being passed to switch 1092 that provides for switching between alb or c, with the chosen signal a/b/c being passed to switch 1094 that provides for switching between a/b/c and d. Switching block 1042 then passes one of the signals a-d to bypass switch 1048, which provides for a choice between a/b/c/d and bypass path 1096. The signal selected by bypass switch 1048 then passes to output line 1098.

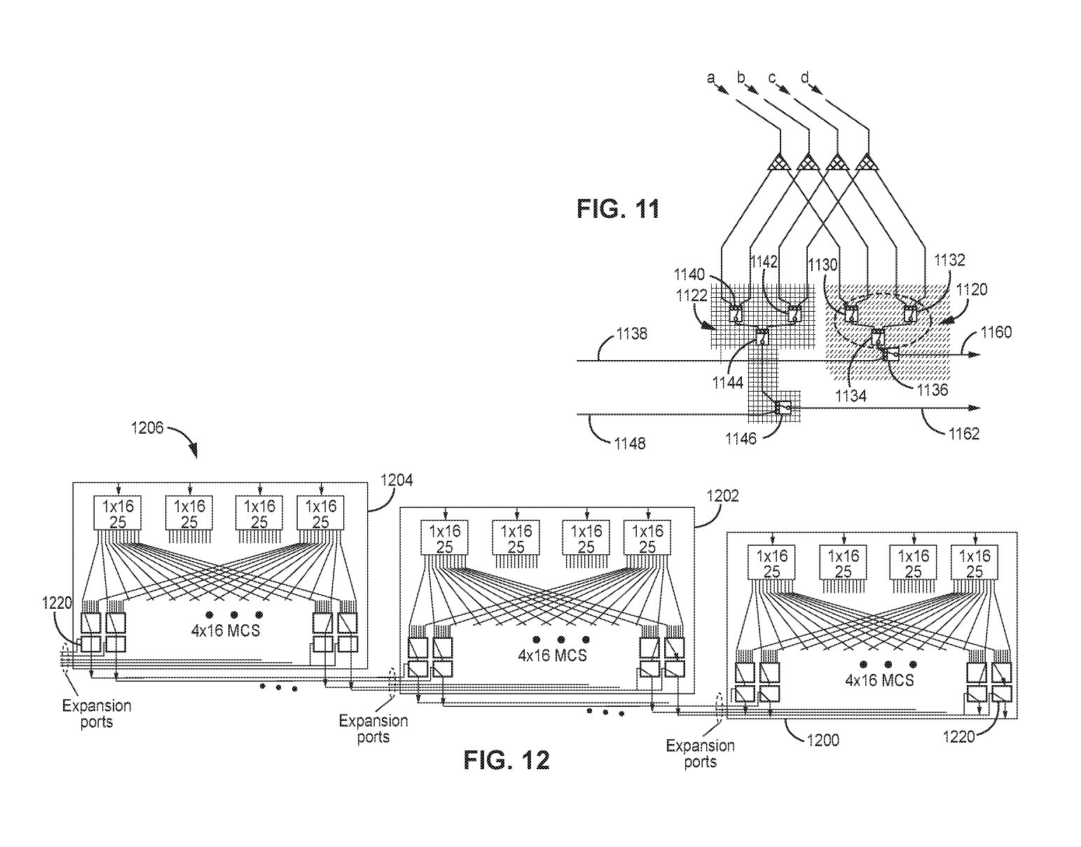

FIG. 11 depicts an alternative sub-portion for an expandable switch with an alternative switching block design. Switching blocks 1120, 1122 are arranged in a tree configuration and are a functionally-equivalent alternative to switching blocks 1040 and 1042 of FIG. 10. In block 1120, switch 1130 is selectable between a and b inputs to provide output a/b and switch 1132 is selectable between c and d inputs to provide output c/d. Switch 1134 is selectable between a/b and c/d to provide an output a/b/c/d to bypass switch 1136, which is, in turn selectable between a/b/c/d or bypass signal from bypass channel 1138. Switches 1140, 1142, 1144, and 1146 are similarly configured to provide selectivity between any of a-d and bypass channel 1148. Bypass switches 1136, 1146 respectively connect to outputs 1160, 1162.

The basic architecture of a 4×16 degree-expandable MCS in the drop direction is shown in FIG. 12, in which three 4×16 MCS 1200, 1202, 1204 are configured as an effective 12×16 MCS 1206 based on expansion capabilities. It is based on a basic 4×16 MCS except that at the bottom layer there is an array of 1×2 optical switches 1220 (in which only two are labeled in the figure to avoid clutter) to make the switch expandable. Each 1×2 optical switch has an output port that corresponds to one of the 16 output ports, and has two input ports with one connecting to the original output port and the other connecting to one of the expansion ports. With respect to the 4×16 MCS 1200 which gets deployed first (i.e., the right-most one in FIG. 12), if no degree expansion beyond 4 is needed, the 1×2 optical switches toggles to the right; while if 8-degree traffic needs to be supported, one or more of its 1×2 optical switches toggles to the left, and the second 4×16 MCS is added through the expansion ports (i.e., the middle one in FIG. 1). The two cascaded 4×16 MCSs then become an 8×16 MCS. Similarly, 12×16 (as shown in FIG. 7) and 16×16 MCS can be formed by cascading three and four 4×16 MCSs, respectively.

The main advantage of this architecture is that one can cover 4, 8, 12, 16, and even up to 20 degrees or more by using the same 4×16 MCS as the basic module. If the MCS switches are also configured with another row of switches on the inputs with corresponding expansion out bypass channels, the MCS can similarly be expanded with respect to ultimate numbers of output degrees.

In an optical network, a signal to be communicated generally is converted at some location from an electrical signal to an optical signal. The optical signal is generally multiplexed for longer range transmission. Various switching, amplifications and signal conversions may or may not take place in directing the optical signal. The optical signal is then received at a node, such as a metro node where the specific signal is separated from other commonly transported signals and switched, for example, to be sent to the specific recipient. In certain state of the art optical communication systems, optical signals are sent coherently such that the phase and amplitude can distinguish the optical signal, and correspondingly, optical receivers can be integrated (e.g., intradyne) coherent receivers that provide for the tracking of the phase between the optical signal and the local oscillator, for example, using the intradyne principle. Integrated coherent receivers are available commercially from NeoPhotonics Corporation. The intradyne principle is based on the tracking of the phase with digital processing after the signal is converted with an analog to digital processing.

The optical signal-to-noise ratio (OSNR) is a measure of the robustness of the signal and quantifies the risk of signal loss to the noise during the signal processing. Amplification can boost the OSNR at the expense of cost and power consumption.

In a metro optical network, however, a higher OSNR can be achieved due to its shorter inter-spans between EDFAs, and shorter total transmission distance. In the extreme case when there is no optical amplifier in the system, the beat noise between a local-oscillator (LO) and amplifier spontaneous emission (ASE) noise is completely removed, and this avoids the impairment of an ICR's effective sensitivity that occurs when presented with such beat noise. Systems without drop side amplification are described further in the '520 patent cited above. In improved drop side ROADM components use single wavelength amplification downstream from the MCS to provide higher OSNR with modest power consumption.

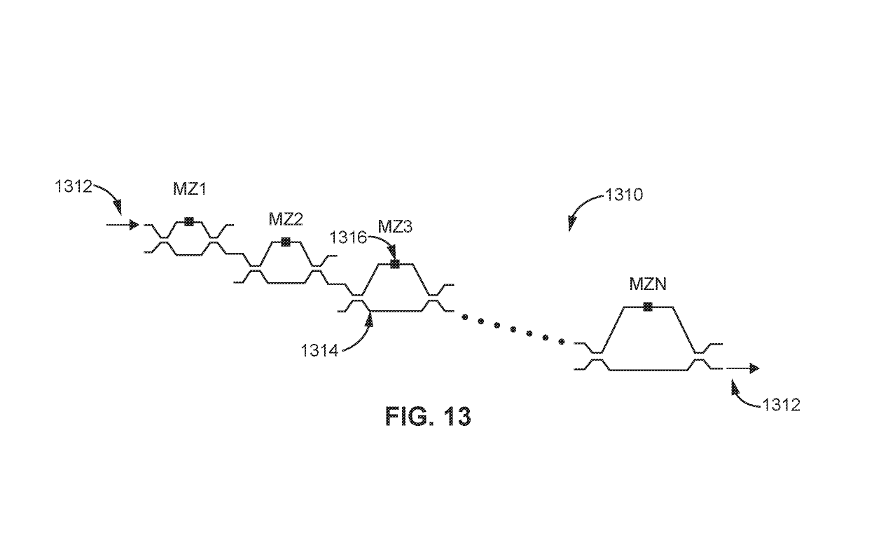

Referring to FIG. 13, a prior-art tunable optical filter 1310 design is shown, having cascaded Mach-Zehnder (MZ) interferometers MZ1, MZ2, . . . , MZN connected in series. This TOF design can be incorporated into the improved ROADM components described herein. An optical signal 1312 is applied to the first interferometer MZ1, the signal 1312 exiting the filter 1310 at an output waveguide of the last interferometer MZN. Each of the interferometers MZ1 . . . MZN has two branches 1314 and 1316, in which at least one of the branches has a phase shifter, such as a thermal heating element that shifts the phase based on thermal changes in the index of refraction. The phase shift provides filtering capability. The repeated stages of MZ1 provide refinement of the filtering functions, and two, three or more stages can be used to achieve a desired wavelength filtering performance.

Additional discussion of tunable filters can be found in U.S. Pat. No. 6,208,780 entitled “System and Method for Optical Monitoring”, issued to Li et al. of Lucent Technologies and incorporated herein by reference. Li et al. generally teaches a tunable optical filter on a PLC chip using cascaded unbalanced MZ interferometers.

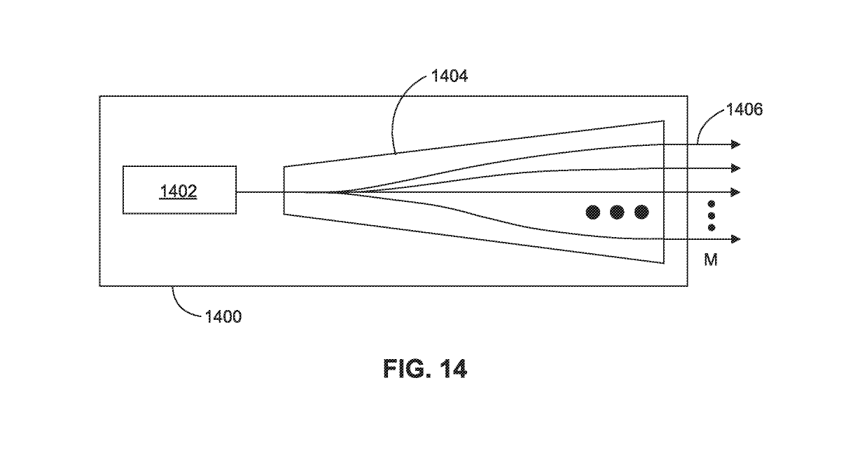

Referring to FIG. 14, a schematic view is shown of an embodiment of a distributed pump source 1400 for providing pump light to the EDFAs, according to one or more embodiments. In various embodiments the distributed pump source 1400 comprises a pump laser 1402 coupled to a 1×M optical splitter 1404 that provides a connection with a plurality of optical conduits 1406.

In one or more embodiments, and as described above with reference to at least FIGS. 4, 5A, 6, and 7A-7B, the plurality of optical conduits 1406 are connected to optical couplers that couple pump light emitted from the pump laser 1402 with various input signals intended for the EDFAs. In such embodiments, an alternative and more versatile form of pump sharing is provided in which laser power is dynamically distributed across a laser array to provide desired output for a particular channel receiving pump light from the laser diode array.

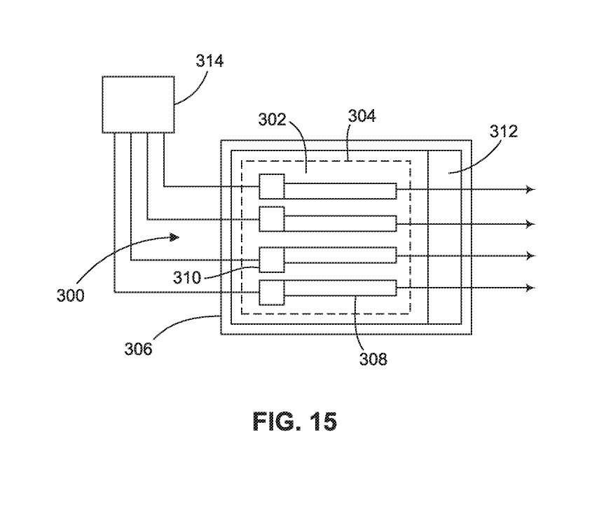

Referring to FIG. 15, the dynamic distribution of laser power through the design of a laser diode on a common substrate with a controller to implement the dynamic power distribution is shown schematically. In various embodiments the pump laser array 300 comprises a substrate 302, a base electrode 304, a thermal cooling element 306, an array of laser elements 308, a corresponding array of drive electrodes 310, output waveguide array 312, shown schematically in this view, and controller 314. Base electrode 304 is shown in phantom lines in FIG. 15 since it may not be visible in a top view. Base electrode may be smaller, larger or commensurate with the bottom of substrate independently in various dimensions, and the shape of base electrode 304 may or may not be the same as the shape of the bottom of substrate 302 as long as base electrode 304 can function as one electrode for laser elements 308.

Generally, substrate 302 can be formed from any stable material with an appropriate surface and some electrical conductivity. To provide for the processing of the other components, substrate 302 generally should be able to tolerate relatively high temperatures, and suitable materials include silicon wafers, indium phosphide, other semiconductors or the like.

Electrodes 304, 310 generally are formed as metal films, although any electrically conductive material can be used in principle. Metal film electrodes can be formed by physical vapor deposition, sputtering or the like. Also, metal film electrodes can be formed with metal paste or inks, such as silver pastes with silver nanoparticles that can be thermally processed into highly conductive films. Pattering of electrodes 310 can be performed, for example, with photolithographic etching or with selective printing of a silver paste or other suitable approach. While FIG. 15 displays the device with a single base electrode providing connections to all of the lasers in array 308, individual or group electrodes can be used if desired, in which the base electrodes are appropriately patterned. However, a single base electrode can be processed conveniently and can be used, for example, as the electrical ground to provide for stable operation of the lasers. Cooling element 306 can be a thermoelectric cooler, heat spreader, heat sink or the like.

Various designs of the laser elements in array 308 can be used with effective results. Common elements of the laser elements are p-doped semiconductor material and n-doped semiconductor material forming a p-n junction. Many diode laser designs have multiple alternating layers of compound semiconductors, and lasing can originate from the alternating layers, which can function as a quantum well with holes and electrons injected from the surrounding doped semiconductor layers. The ends of the laser element can have straight terminated edges that complete the resonator or laser cavity with light reflecting back through the resonator until lasing occurs. The edge of the laser cavity opposing the emitting edge can be coated with a reflective surface coating that generally reflects at least 90% of the light back through the cavity. Current flows laterally through the structure between the electrodes of opposite polarity, and the current flow drives the lasing.

In some embodiments of the laser modules, multiple individual laser die are assembled into an array within a single package having an operating rule specifying the total optical output power of the package. In the example of an EDFA, pump lasers would preferably provide optical power at a free-space wavelength near either 980 nanometers (nm) or 1480 nm, with 980 nm being typically more efficient and frequently preferred. Therefore, certain key embodiments of the devices would comprise multiple semiconductor laser elements emitting at about 980 nm, though the invention clearly also supports use of other types of lasers and at other emission wavelengths. The construction of semiconductor laser structures is dependent on many factors relating to a specific application. The construction of semiconductor lasers is covered extensively in the known art, for instance in the textbook ‘Semiconductor Lasers’ by Agrawal and Dutta, Van Nostrand Reinhold publishers, July 1993 2^{nd} edition (ISBN 0442011024). In pump lasers for telecommunications amplifiers, many laser structures conform to similar basic principles. The film layers establishing the laser are grown on a wafer of binary compound semiconductor such as Gallium Arsenide (GaAs) or Iridium Phosphide (InP). The films may be grown for instance by molecular-beam epitaxy (MBE), chemical beam epitaxy (CBE), metal-organic molecular beam epitaxy (MOMBE), or metalorganic vapor phase epitaxy/metalorganic vapor chemical deposition (MOVPE/MOCVD).

Additional discussion of a dynamically distributed laser pump array is described further in U.S. Pat. No. 9,660,421 to Vorobeichik et al., entitled “Dynamically-Distributable Multiple-Output Pump for Fiber Optic Amplifier,” incorporated herein by reference.

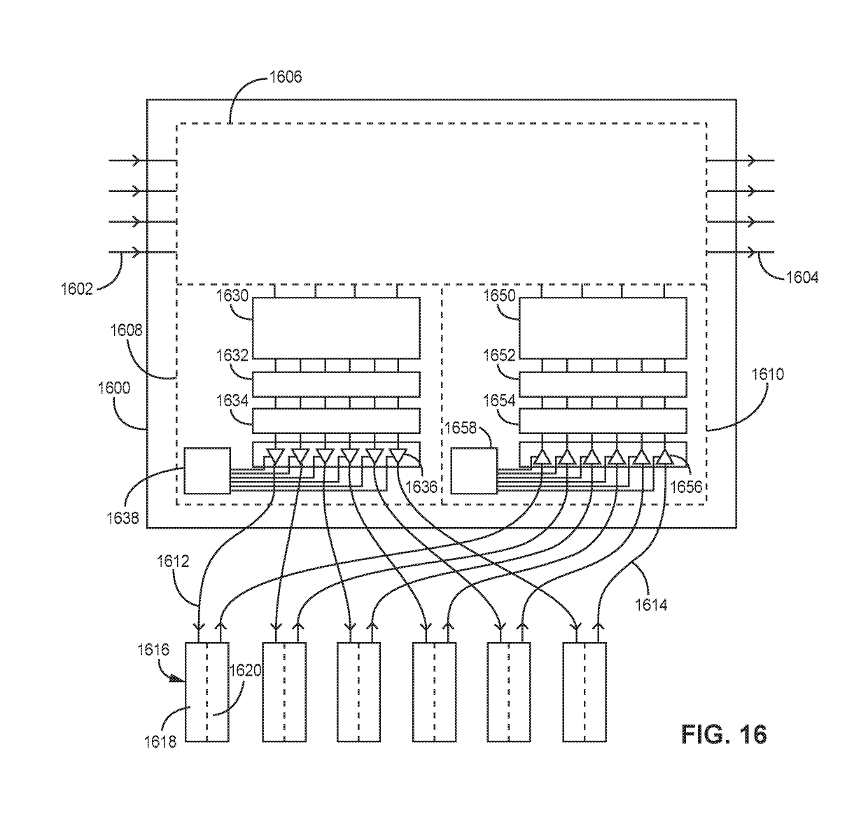

Referring to FIG. 16 a schematic view of a ROADM 1600 is depicted, according to one or more embodiments. The ROADM 1600 comprises a plurality of network input optical conduits 1602, a plurality of network output optical conduits 1604, and an optical cross-connect switch 1606.

In various embodiments, the optical cross-connect switch 1606 is configured to provide a variety of optical pathways to connect the input optical conduits 1602 with the output optical conduits 1604 along with allowing add/drop functionality. In such embodiments, cross-connect switch 1606 can comprise a plurality of optical splitters and/or a plurality of wavelength selective switches (WSSs) that are configured to provide an optical passageway through the ROADM 1600, such as described above with reference to FIG. 3.

In addition, in various embodiments the ROADM 1600 comprises a drop-side component 1608 and add-side component 1610. In one or more embodiments, the optical passageways provided by the cross-connect switch 1606 additionally comprises one or more optical channels that are configured as drop ports—optically connected with the drop-side component 1608 for dropping one or more signals received via the input optical conduits 1602. Similarly, in various embodiments the optical passageways provided by the cross-connect switch 1606 comprises one or more optical channels that are configured as add ports—optically connected with the add-side component 1610 for adding one or more signals into the network core via the output optical conduits 1604. In general, drop ports can be connected to receivers that convert the dropped optical signals to corresponding electrical signals, and add ports can be connected to a corresponding transmitter that converts electrical signals into corresponding optical signals for transmission.

In the embodiment shown in FIG. 16, the drop side component 1608 comprises an MCS 1630 with P optical conduits (user-facing) and N optical conduits (line-facing), a drop-side M channel variable optical attenuator array 1632, a drop-side M channel tunable optical filter array 1634, and a set of M single wavelength EDFA 1636. In some embodiments P=M, and in alternative embodiments P>M in which the P−M additional switch channels can be used for contention mitigation or can represent expansion capability for the addition of future users. Optionally, other drop side components can be configured with P channels to provide for expansion capability. To simplify the discussion, the following description refers to P=M, although it should be recognized that P can be greater than M. Depicted in FIG. 16, each of the MCS 1630, optical attenuator array 1632, drop-side TOF 1634, and EDFA 1636 are optically connected in sequence such that an input signal first enters the drop-side component 1608 by entering the MCS 1630, passing through the optical attenuator array 1632 and TOP 1634 in sequence, and then passes out of the drop side component 1608 via the EDFA 1636.

In addition, in various embodiments the drop side component 1608 additionally comprises a pump laser 1638 optically connected with the EDFA 1.636. Implicitly, each EDFA component of the EDFA 1636 can also connect with an optical coupler to couple an input and pump signal from the pump laser 1638, as described above.

In one or more embodiments, add side component 1610 comprises an MCS 1650 with P optical conduits (user-facing) and N optical conduits (line-facing), an add-side M channel variable optical attenuator array 1652, an add-side M channel tunable optical filter array 1654, and a set of M single wavelength EDFA 1656. Generally, P≥M, and if P>M, the additional channels can be used for subsequent expansion. Optionally, the other add-side components can individually also be configured with P rather than M channels to provide expansion capability. Depicted in FIG. 16, each of the MCS 1630, optical attenuator array 1632, add-side TOF 1634, and EDFA 1636 are optically connected in sequence such that an input signal first enters the add-side component 1610 by entering via the EDFA 1656, passing through the TOF 1654 and attenuator array 1652 in sequence, and then passes back into the cross-connect switch 1606 via the MCS 1650.

In addition, in various embodiments the add side component 1610 additionally comprises a pump laser 1658 optically connected with the EDFA 1656. As described, each EDFA component of the EDFA 1656 implicitly connect with an optical coupler to couple an input and pump signal.

In various embodiments, the drop side component 1608 and add side component 1610 are optically connected with a plurality of user transceivers 1616 (M transceivers, where M is an integer >1), via a plurality of user drop optical conduits 1612 and user add optical conduits 1614, respectively. In certain embodiments, the user transceivers 1616 comprise an internal receiver 1618 and transmitter 1620, although the transmitter and receiver can be packaged separately if desired. In such embodiments, the receiver 1618 may be optically connected with the output of the drop-side component 1608 while the transmitter 1620 may be optically connected with the input of the add-side component 1610.

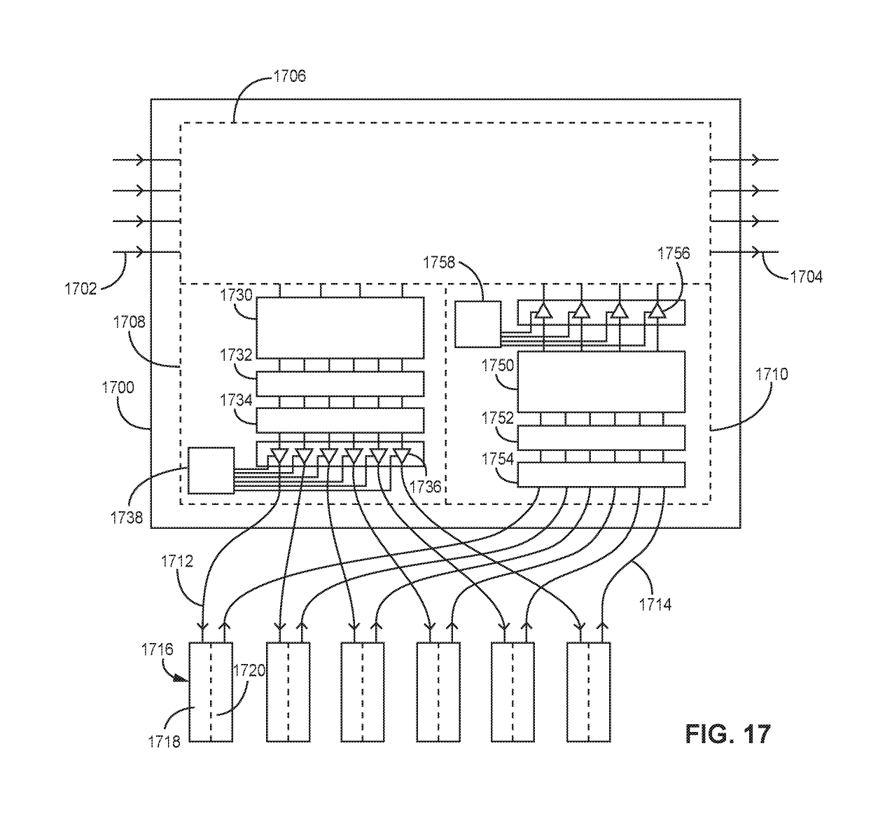

Referring to FIG. 17 a schematic view of a ROADM 1700 is depicted, according to one or more embodiments. In such embodiments, the ROADM 1700 comprises a plurality of network input optical conduits 1702, a plurality of network output optical conduits 1704, and an optical cross-connect switch 1706.

In various embodiments the optical cross-connect switch 1706 is configured to provide a variety of optical pathways to connect the input optical conduits 1702 with the output optical conduits 1704. In such embodiments, cross-connect switch 1706 could comprise a plurality of optical splitters and/or a plurality of wavelength selective switches (WSSs) that are configured to provide an optical passageway through the ROADM 1700, such as described above with reference to FIG. 3, as well as to provide add and drop functionality.

In addition, in various embodiments the ROADM 1700 comprises a drop-side component 1708 and add-side component 1710. In one or more embodiments the optical passageways provided by the cross-connect switch 1706 comprises one or more optical channels that are configured as drop ports—optically connected with the drop-side component 1708 for dropping one or more signals received via the input optical conduits 1702. Similarly, in various embodiments the optical passageways provided by the cross-connect switch 1706 comprise one or more optical channels that are configured as add ports—optically connected with the add-side component 1710 for adding one or more signals into the network core via the output optical conduits 1704. In general, drop ports can be connected to receivers that convert the dropped optical signals to corresponding electrical signals, and add ports can be connected to a corresponding transmitter that converts electrical signals into corresponding optical signals for transmission.

In one or more embodiments, the drop side component 1708 comprises a MCS 1730 with P optical conduits (user-facing) and N optical conduits (line-facing), a drop-side M channel variable optical attenuator array 1732, a drop-side M channel tunable optical filter array 1734, and a set of M single wavelength EDFA 1736. In some embodiments P=M, and in alternative embodiments P>M in which the P−M additional switch channels can be used for contention mitigation or can represent expansion capability for the addition of future users. Optionally, other drop side components can be configured with P channels to provide for expansion capability. To simplify the discussion, the following description refers to P M, although it should be recognized that P can be greater than M. As depicted in FIG. 17, each of the MCS 1730, optical attenuator array 1732, drop-side TOF 1734, and EDFA 1736 are optically connected in sequence such that an input signal first enters the drop-side component 1708 by entering the MCS 1730, passing through the variable optical attenuator array 1732 and drop-side TOF 1734 in sequence, and then passes out of the drop side component 1708 via the EDFA 1736.

In addition, the drop side component 1708 additionally comprises a pump laser 1738 optically connected with the EDFA 1736. Implicitly, each EDFA component of the EDFA 1736 also connects with an optical coupler to couple an input and pump signal, as described above.

In one or more embodiments, the add side component 1710 comprises a MCS 1750 with P optical conduits (user-facing) and N optical conduits (line-facing), an add-side M channel variable optical attenuator array 1752, an add-side M channel tunable optical filter array 1754, and a single wavelength EDFA 1756. Generally, P≥M, and if P>M, the additional channels can be used for subsequent expansion. Optionally, the other add-side components can individually also be configured with P rather than M channels to provide expansion capability. Depicted in FIG. 16, each the EDFA 1756, MCS 1750, optical attenuator array 1752, and add-side TOF 1734 are optically connected in sequence such that an input signal first enters the add-side component 1710 by entering via the TOE 1734 and passing through the attenuator array 1752 and MCS 1750 in sequence, and then exits the component 1710 by passing back into the cross-connect switch 1706 via the EDFA 1.756.

In addition, the add side component 1710 additionally comprises a pump laser 1758 optically connected with the EDFA 1756. Implicitly, each EDFA component of the EDFA 1756 also connects with an optical coupler to couple an input and pump signal, as described above.

In various embodiments, the drop side component 1708 and add side component 1710 are optically connected with a plurality of user transceivers 1716 (M transceivers, where M is an integer >1), via a plurality of user drop optical conduits 1712 and user add optical conduits 1714, respectively. In certain embodiments the user transceivers 1716 comprise an internal receiver 1718 and transmitter 1720, although the receiver and transmitter can be packaged separately. In general, the receiver 1718 may be optically connected with the output of the drop-side component 1708 while the transmitter 1720 may be optically connected with the input of the add-side component 1710.

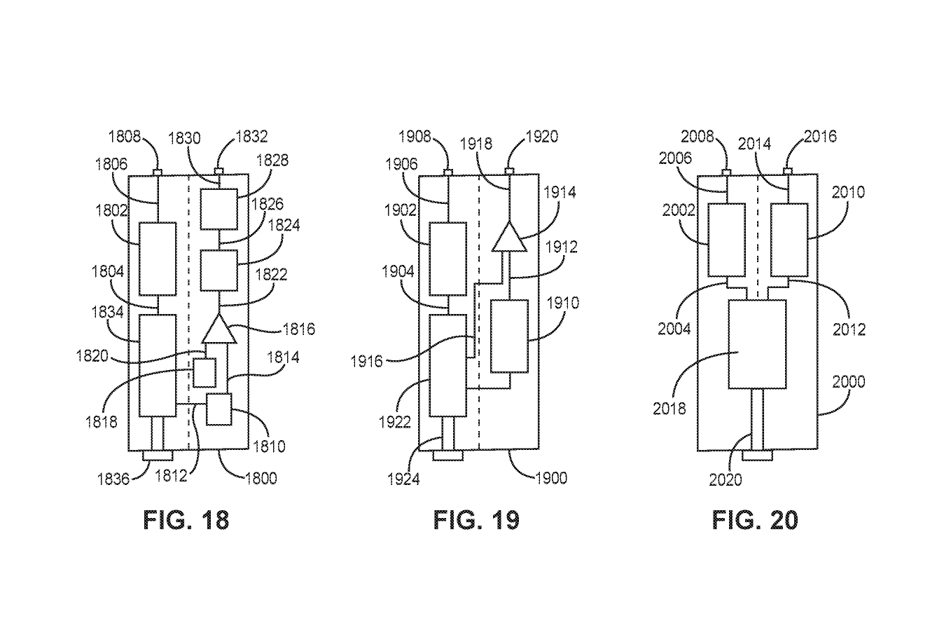

Referring to FIG. 18 a schematic view of a user transceiver 1800 is depicted, according to one or more embodiments. In certain embodiments, the transceiver 1800 comprises a receiver portion and a transmitter portion.

In one or more embodiments, the receiver portion comprises an exterior optical connector 1808 optically connected with an optical receiver 1802, controller chip 1834, and an electrical connector 1836. In such embodiments, the receiver portion comprises a plurality of various internal optical connections including optical conduits 1806, 1804, that connect the various components of the receiver portion together. In addition, in one or more embodiments the electrical connector 1836 is electrically connected with the controller 1834 for receiving power and/or receiving or sending various electrical control signals to an exterior connected device.

In various embodiments the transmitter portion comprises an optical transmitter 1810, optical amplifier 1816 with pump laser 1818, tunable optical filter 1824, variable optical attenuator 1828, and exterior optical connector 1832. In such embodiments, the transmitter portion comprises a plurality of various internal optical connections including optical conduits 1814, 1820, 1822, 1826, 1830 that connect the various components of the receiver portion together. In addition, in one or more embodiments the receiver portion and transmitter portion are electrically connected via an electrical connection 1812 that electrically connects the controller 1834 with the optical transmitter 1810.

In operation, in various embodiments the receiver portion is configured to receive one or more input signals via the optical connector 1808 and pass the received input along to the optical receiver 1802. In such embodiments, the controller 1834, receiving indications of the received input from the optical receiver 1802 can read the received signal and translate the signal into electrical signals that can be sent externally of the user transceiver 1800 as an electrical signal via the electrical connector 1836. Also, controller 1834 can receive electrical signals from the electrical connections to transmission to the network through instruction of optical transmitter 1810 to construct/transmit an optical output via the transmitter portion.

Referring to FIG. 19 a schematic view of a user transceiver 1900 is depicted, according to one or more embodiments. In certain embodiments, the transceiver 1900 is particularly useful for use with certain designs/configurations of a ROADM, such as ROADM 1700 depicted above with reference to FIG. 17.

In one or more embodiments the transceiver 1900 comprises a receiver portion and a transmitter portion. In one or more embodiments the receiver portion comprises an exterior optical connector 1908 optically connected with an optical receiver 1902, controller chip 1922, and an electrical connector 1924. In such embodiments, the receiver portion comprises a plurality of various internal optical connections including optical conduits 1906, 1904, that connect the various components of the receiver portion together. In addition, in one or more embodiments the electrical connector 1924 is electrically connected with the controller 1922 for receiving power and/or receiving or sending various electrical control signals to an exterior connected device.

In various embodiments the transmitter portion comprises an optical transmitter 1910, solid state optical amplifier 1914, and exterior optical connector 1920. In such embodiments, the transmitter portion comprises a plurality of various internal optical connections including optical conduits 1912, 1918, that connect the various components of the receiver portion together. In addition, in one or more embodiments, an electrical connection 1916 electrically connects the controller 1834 with the solid state optical amplifier. As cited earlier, the present invention is equally applicable if solid-state semiconductor optical amplifiers (SOAs) are used instead of EDFAs and pump lasers. Solid state amplifiers generally provide optical amplification based on electrical stimulation without the need for an optical pump, and solid state amplifiers are commercially available, such as from Inphenix Inc. Controller 1834 is also electrically connected with transmitter 1910.

In operation, in various embodiments the receiver portion is configured to receive one or more input signals via the optical connector 1908 and pass the received input along to the optical receiver 1902. In such embodiments, the controller 1922, receiving indications of the received input from the optical receiver 1902 can read the received signal and translate the signal into an electrical signal that can be sent externally of the user transceiver 1900 as an electrical signal via the electrical connector 1924. Also, controller 1922 can receive an electrical signal and instruct optical transmitter 1910 to construct/transmit an optical output via the transmitter portion based on the electronic signal.

Referring to FIG. 20 a schematic view of a user transceiver 2000 is depicted, according to one or more embodiments. In certain embodiments, the transceiver 2000 is particularly useful for use with certain designs/configurations of a ROADM, such as ROADM 1600 depicted above with reference to FIG. 16.

In one or more embodiments, the transceiver 2000 comprises a receiver portion and a transmitter portion. In one or more embodiments, the receiver portion comprises an exterior optical connector 2008 optically connected with an optical receiver 2002. In such embodiments, the receiver portion comprises a plurality of various internal optical connections including optical conduit 2006 that connect the various components of the receiver portion together. Receiver 2002 has an electrical connection 2004 with controller chip 2018.

In various embodiments the transmitter portion comprises electrical connector 2020, optical transmitter 2010, and exterior optical connector 2016. Electrical connector 2020 connects optical transmitter 2010 with controller chip 2018. In such embodiments, t transmitter portion comprises a plurality of various internal optical connections including optical conduits 2012, 2014, that connect the various components of the receiver portion together. In addition, in one or more embodiments the electrical connector 2020 is electrically connected with the controller 2018 for receiving power and/or receiving or sending various electrical control signals to an exterior connected device.

In operation, in various embodiments the receiver portion is configured to receive one or more input signals via the optical connector 2008 and pass the received input along to the optical receiver 2002.

In such embodiments, the controller 2018, receiving indications of the received input from the optical receiver 2002 can read the received signal and translate the signal into an electrical signals that can be sent externally of the user transceiver 2000 as an electrical signal via the electrical connector 2020. Also, controller 2018 can receive electronic signals from electrical connector 2020 to instruct the optical transmitter 2010 to construct/transmit an optical output via the transmitter portion.

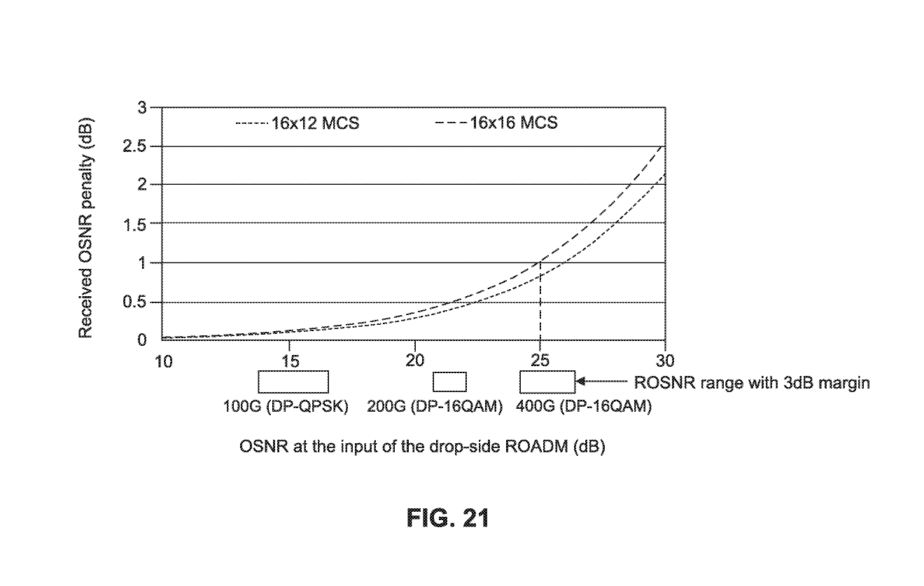

Referring to FIG. 21, calculations of optical signal to noise ratio (OSNR) penalty at the signal destination for models based on the structures described herein are presented. Based on this plot, it can be appropriate to consider use of up to a 16×16 MCS to keep the OSNR penalty <1 dB at the drop side. If a 16×24 or 16×32 MCS is to be used, on the drop side an array of gain-clamped, which would allow for pump sharing, or regular EDFAs without pump sharing can be used at the input of the drop side N×M MCS.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understood that the disclosure herein covers the specific embodiments, embodiments comprising the specific components, elements, ingredients, other partitions or combinations thereof as well as embodiments consisting essentially of such specific components, ingredients or other partitions or combinations thereof that can comprise additional features that do not change the fundamental nature of the subject matter, as suggested in the discussion, unless otherwise specifically indicated.

What is claimed is:

1. A reconfigurable optical add/drop multiplexer component comprising:
an N×M multicast switch connected to N network side optical conduits, wherein N, M are integers each ≥1;
a tunable optical filter with P or M channels (1≤P≤M) and with two sets of P or M optical ports wherein a first set of optical ports are connected by optical conduits to the N×M multicast switch;
P optical amplifiers with each optical amplifier connected to a distinct optical port of the tunable optical filter; and
P user side ports connected to the P optical amplifiers and to P light conduits each connected to a user transceiver,
wherein the N×M multicast switch and the tunable optical filter are planar optical circuits and wherein the P optical amplifiers are configured for single wavelength amplification.

2. The reconfigurable optical add/drop multiplexer component of claim 1 wherein the optical amplifiers are erbium doped fiber amplifiers.

3. The reconfigurable optical add/drop multiplexer component of claim 2 further comprising a distributed pump laser configured to drive a plurality of the erbium doped fiber amplifiers.

4. The reconfigurable optical add/drop multiplexer component of claim 1 wherein the optical amplifiers are semiconductor optical amplifiers.

5. The reconfigurable optical add/drop multiplexer component of claim 1 wherein the N network side optical conduits of the MCS are connected directly to a wavelength selective switch without an intervening optical amplifier.

6. The reconfigurable optical add/drop multiplexer component of claim 1 further comprising an array of P or M variable optical attenuators configured in a planar optical circuit and connected by optical conduits to the N×M multicast switch such that optical signals between the tunable optical filter and the N×M multicast switch pass through a variable optical attenuator.

7. The reconfigurable optical add/drop multiplexer component of claim 1 wherein the N×M multicast switch comprises a plurality of expandable MCS units wherein at least one MCS unit comprises a 1×2 optical switch on each output connected to an expansion in bypass optical channel and/or a 1×2 optical switch on each input connected to an expansion out bypass optical channel, such that the plurality of expandable MCS units function as the N×M multicast switch.

8. The reconfigurable optical add/drop multiplexer component of claim 1 wherein the N optical conduits are configured for connection to input ports of a reconfigurable optical add/drop multiplexer configured with the reconfigurable optical add/drop multiplexer component connected in a drop configuration and the P user side ports are connected to inputs of the user transceiver.

9. An add-side reconfigurable optical add/drop multiplexer component comprising:
a PLC based N×M multicast switch connected to N network side optical conduits, wherein N, M are integers each ≥1;
a PLC based array of P or M variable optical attenuators (1≤P≤M) with two sets of P or M optical ports wherein a first set of optical ports are connected by optical conduits to the N×M multicast switch; and
a PLC based tunable optical filter array with P or M channels (1≤P≤M) and with two sets of P or M optical ports wherein a first set of optical ports are connected by optical conduits to corresponding P or M ports of the PLC based array of variable optical attenuators and a second set of P or M ports are connected to P light conduits connected to output ports of a user transceiver.

10. The reconfigurable optical add/drop multiplexer component of claim 9 wherein the variable optical attenuator and the tunable optical filter are integrated into a single planar lightwave circuit.

11. The reconfigurable optical add/drop multiplexer component of claim 10 wherein N×M multicast switch is integrated in the planar light wave circuit with the variable optical attenuator and the tunable optical filter.

12. The reconfigurable optical add/drop multiplexer component of claim 9 wherein the tunable optical filter comprises a series of Mach-Zehnder Interferometers and wherein the variable optical attenuator comprises a Mach-Zehnder Interferometer.

13. The reconfigurable optical add/drop multiplexer component of claim 9 wherein the N×M multicast switch comprises a plurality of expandable MCS units wherein at least one MCS unit comprises a 1×2 optical switch on each output connected to an expansion in bypass optical channel and/or a 1×2 optical switch on each input connected to an expansion out bypass optical channel, such that the plurality of expandable MCS units function as the N×M multicast switch.

14. The reconfigurable optical add/drop multiplexer component of claim 9 further comprising N single wavelength erbium doped fiber amplifiers (EDFA) with each EDFA connected to a distinct one of the N network side optical conduits.

15. The reconfigurable optical add/drop multiplexer component of claim 14 further comprising a distributed pump laser configured to drive a plurality of the erbium doped fiber amplifiers.

16. The reconfigurable optical add/drop multiplexer component of claim 9 further comprising N single wavelength semiconductor optical amplifiers (SOA) with each SOA connected to a distinct one of the N network side optical conduits.

17. An optical telecommunications node comprising:
N input optical signal conduits, wherein N is an integer ≥1;
N output optical signal conduits;
M single wavelength input optical signal conduits, wherein M is an integer ≥1;
M single wavelength output optical signal conduits;
a reconfigurable optical add/drop multiplexer (ROADM) comprising an add side PLC multicast switch, a drop side PLC multicast switch, two arrays of PLC tunable optical filters (TOF) with one array of TOF configured on the add configuration multicast switch and with one array of TOF configured on the drop configuration multicast switch, wherein the ROADM connects the N input optical signal conduits with the M single wavelength output optical conduits through the drop side multicast switch and connects the N output optical signal conduits with the M single wavelength input signal conduits through the add side multicast switch;
P input single wavelength optical fibers, P≤M, wherein each input single wavelength optical fiber is configured in an add configuration to receive an optical signal from a transmitter; and
P output single wavelength optical fibers, wherein each output single wavelength optical fiber is configured in a drop configuration to transmit an optical signal to a receiver.

18. The optical telecommunication node of claim 17 wherein the ROADM further comprises single wavelength erbium doped fibers amplifiers connected to each output port (user side) of the drop configuration multicast switch and a distributed pump laser configured to drive a plurality of the erbium doped fiber amplifiers.

19. The optical telecommunication node of claim 17 wherein the ROADM further comprises single wavelength erbium doped fibers amplifiers connected to each output port (network side) of the add configuration multicast switch and a distributed pump laser configured to drive a plurality of the erbium doped fiber amplifiers.

20. The optical telecommunication node of claim 17 wherein the ROADM further comprises single wavelength erbium doped fibers amplifiers connected to each output port (user side) of the drop configuration multicast switch and a distributed pump laser configured to drive a plurality of the erbium doped fiber amplifiers and single wavelength erbium doped fibers amplifiers connected to each output port (network side) of the add configuration multicast switch and a distributed pump laser configured to drive a plurality of the erbium doped fiber amplifiers.

21. The optical telecommunication node of claim 17 wherein the tunable optical filter comprises a series of Mach-Zehnder Interferometers, wherein the ROADM further comprises an array of add side variable optical attenuators and an array of drop side variable optical attenuators with the variable optical attenuators comprising a Mach-Zehnder Interferometer, and wherein the N×M multicast switch comprises a plurality of expandable MCS units wherein at least one MCS unit comprises a 1×2 optical switch on each output connected to an expansion in bypass optical channel and/or a 1×2 optical switch on each input connected to an expansion out bypass optical channel, such that the plurality of expandable MCS units function as the N×M multicast switch.

22. The optical telecommunication node of claim 17 wherein the transmitters and receivers comprise a semiconductor optical amplifier connected to output ports and are free of tunable optical filters.
